(19) United States
(12) Patent Application Publication
(10) Pub. No.: US 2012/0275518 A1
(43) Pub. Date: Nov. 1, 2012

(54) MOVING PICTURE CODING METHOD, APPARATUS, PROGRAM, AND INTEGRATED CIRCUIT

(76) Inventors: Shinya Kadono, Hyogo (JP); Hidekatsu Ozeki, Gifu (JP); Yasuhiro Mamiya, Aichi (JP)

(21) Appl. No.: 13/001,072

(22) PCT Filed: Jul. 7, 2010
(86) PCT No.: PCT/JP2010/004431

§ 371 Date: Dec. 23, 2010

(30) Foreign Application Priority Data
Jul. 10, 2009 (JP) 2009-163843

(51) Int. Cl. H04N 7/32; H04N 7/28

(52) U.S. Cl. 375/240.14; 375/240.16; 375/E07.125; 375/E07.243

(57) ABSTRACT

A moving picture coding method in which the position of a current I-slice for a current picture is shifted in the vertical direction of the current picture, and which includes (i) performing inter coding on a first P-slice without using a motion vector (Sa1), and (ii) performing intra coding on a second P-slice using a motion vector (Sa2); the first P-slice is included in a first region that is adjacent to the current I-slice in the direction opposite to the forward direction for the shift in the vertical direction, and the second P-slice is included in a second region that is other than the first region within the current picture.

### TECHNICAL FIELD

The present invention relates to moving picture coding methods and moving picture coding apparatuses. The present invention particularly relates to moving picture coding methods and moving picture coding apparatuses for dividing an image signal into slices including plural blocks, and coding each of the slices in units of a block according to the MPEG-(Moving Picture Experts Group) 4 AVC standard (also called as ITU-T H.264 standard).

### BACKGROUND ART

Recently, the multi-media era has come in which sound, pictures and other pixel values are integrated into one media, and conventional information media as communication tools like newspapers, magazines, TV, radio and telephone are regarded as the targets of multi-media. Generally, multi-media is a form of simultaneous representation of not only characters but also graphics, sound, and especially pictures. In order to handle the above-described conventional information media as multi-media, it is a requisite to represent the information digitally.

However, it is unrealistic to directly process a huge amount of information digitally using the above-described conventional information media because, when calculating the data amount of each information medium described above as digital data amount, data amount per character is 1 to 2 bytes while that of sound per second is not less than 64 K bits (telephone speech quality) and that of moving pictures per second is not less than 100 M bits (present TV receiving quality). For example, a TV telephone has already become commercially practical thanks to Integrated Services Digital Network (ISDN) with a transmission speed of 64 kbps to 1.5 Mbps. However, it is impossible to transmit, using ISDN, moving pictures of TV camera as they are, that is, uncompressed moving pictures.

That is why information compression technique is necessary. For example, a moving picture compression technique standard of H.261 or H.263 which is recommended by the International Telecommunication Union-Telecommunication Standardization Sector (ITU-T) is used for TV telephones. In addition, with the information compression technique of the MPEG-1 standard, it becomes possible to store image information, together with sound information, in a normal CD (Compact disc) for music.

Here, Moving Picture Experts Group (MPEG) is an international standard to digitally compress moving picture signals, and has been standardized by the ISO/IEC (the International Standardization Organization/International Engineering Consortium). MPEG-1 is the standard to compress moving picture signals down to 1.5 Mbps, that is, to compress TV signal information to about one hundredth. In addition, the quality which satisfies the MPEG-1 standard is medium level which can be realized at a transmission rate of about 1.5 Mbps. MPEG-2 is thus standardized in order to satisfy the need for higher picture quality. MPEG-2 compresses moving picture signals to 2 to 15 Mbps to achieve TV broadcasting quality.

At present, the work group (ISO/IEC JTCI/SC29/WG11), which standardized MPEG-1 and MPEG-2, has standardized MPEG-4. The MPEG-4 standard achieves a compression rate higher than those of MPEG-1 standard and MPEG-2 standard, and enables coding, decoding and performing operations on an object-by-object basis, and thereby achieves new functions necessary in this multi-media era. The MPEG-4 standard achieves a compression rate higher than those of MPEG-1 standard and MPEG-2 standard, and enables coding, decoding and performing operations on an object-by-object basis.

The initial object of MPEG-4 standard is to standardize a coding method of pictures with low bit rates, but the object is extended to a general purpose coding method for video including interlace pictures with high bit rates. At present, ISO/IEC and ITU-T, in combination, has standardized MPEG-4 AVC (Advanced Video Coding) as a picture coding method for pictures with a higher compression rate.

Here, an image signal can be considered as a sequence of pictures (that are also referred to as frames or fields) each of which is a set of pixels having the same time. A current pixel has a high correlation with neighbouring pixels within a current picture, and thus the correlation between the pixels in the picture is used in the compression. Consecutive two pictures have high pixel correlation with each other, and thus the pixel correlation between the pictures is used in the compression. Here, compression using (i) correlation between pixels in a picture and pixels in another picture, and (ii) correlation between pixels within a picture is referred to as inter coding. On the other hand, compression using correlation between pixels within a picture without using correlation between pixels in a picture and pixels in another picture is referred to as intra coding. With the use of correlation between pictures, inter coding makes it possible to achieve a compression rate higher than a compression rate obtainable in intra coding.

In MPEG-1, MPEG-2, MPEG-4, MPEG-4 AVC (H.264), intra coding and inter coding can be switched in units of a block which is a set of two-dimensionally arranged pixels each having a square or rectangle area (or in units of a macroblock that is a generic concept of a block and includes plural blocks).

On the other hand, high-speed network environments using ADSL or optical fibers have been widespread. With these environments, data can be communicated at a bit rate of several Mbps at home. Further, it is likely that data can be communicated at a bit rate of several tens of Mbps in the future several years.

When coded image data that is a stream is transmitted via a network, the stream may be partly lost due to network congestion or the like. In the case where the stream is partly lost, a receiving side cannot correctly decode the image corresponding to the lost (part of) stream. Thus, the image quality degrades. To prevent this, a coding unit which is a set of blocks is defined as a slice. A slice is the minimum unit of independent coding and decoding. Decoding can be performed on a slice basis even when a part of a stream is lost.

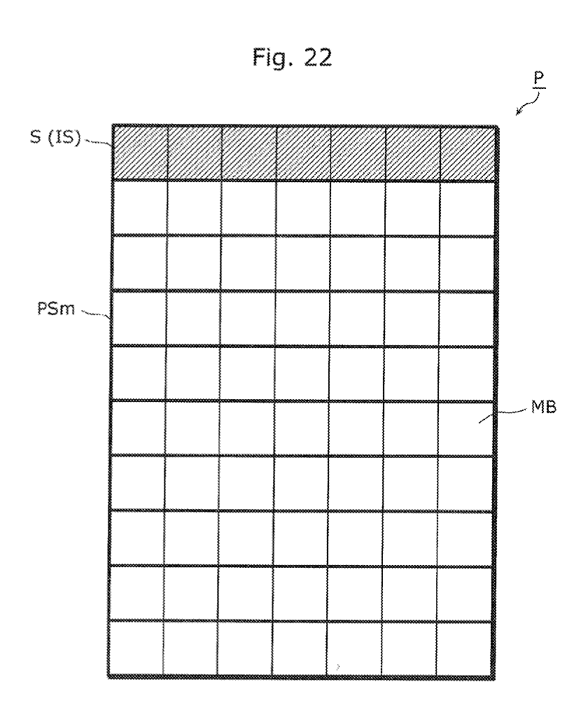

FIG. 22 is a diagram illustrating the relationship between slices S and blocks (macroblock) MB in the case of using a slice division scheme according to the MPEG standard.

A picture P (a frame) shown in FIG. 22 is made up of plural blocks (macroblocks) MB. The blocks MB in a line among the blocks MB constituting the picture P make up of a slice S. In other words, the slice S is made up of plural blocks MB included in the line of the slice S. The picture P includes plural lines each made up of a single slice S. For example, the slice S marked with diagonal lines is an I-slice IS, and each of the other slices is a P-slice PSm. The I-slice IS is a slice made up of only blocks to be intra coded. The P-slice PSm is a slice including blocks to be inter coded. In MPEG-2, a slice S must be made up of only blocks in a same line. In the extension of MPEG-4 or H.264, however, a slice may include plural lines.

In addition, H.264 standard allows inclusion of two kinds of slices, that are, an I-slice and P-slices in a single picture (picture P). In general, an I-slice means a slice to be coded using only correlation between pixels within the slice. A P-slice means a slice to be coded using pixel correlation within the slice and pixel correlation between slices. Here, “between the slices” means “between the P-slice and slice(s) other than the P-slice”. The slice(s) other than the P-slice may be a slice included in a picture different from the picture including the P-slice. Stated differently, the I-slice is a slice for which predictive coding (based on an image signal) using an image signal of a neighbouring pixels (outside the I-slice) is not performed, that is, a slice made up of only intra macroblocks to be intra coded. On the other hand, the P-slice is a slice having a compression efficiency increased by predictive coding, that is, a slice including both inter macroblocks to be inter coded and an intra macroblock.

The H.264 standard includes restrictions on application operation standards, and prohibitions of mixture of an I-slice and a P-slice within a picture. An I-slice in this DESCRIPTION is assumed to include the following slice. The slice also called as an I-slice for simplification is a special P-slice coded intentionally using only correlation between pixels within the P-slice.

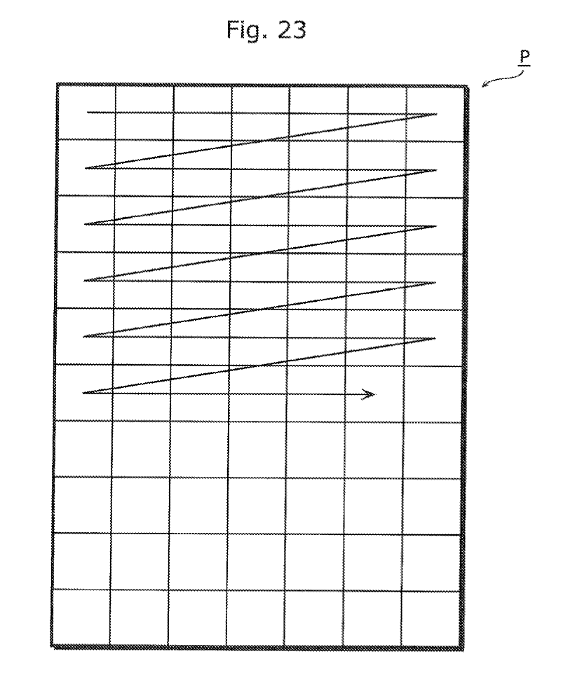

FIG. 23 is a diagram illustrating the coding order of the plural blocks in the picture P.

The blocks MB in the picture P shown in FIG. 22 is coded according to the order shown in FIG. 23, more specifically, from left to right within each slice in the picture P and from top slice to bottom slice within the picture P, which yields a stream.

However, even if a picture is decoded properly in all units of a slice, all the decoded pixels of the picture are not always properly decoded. Here is an example case where some part of a stream is lost. In this case, if the picture next to a picture having a degraded image quality is already intra coded prior to decoding of the next picture, the pixels can be properly decoded based on (only) the intra coded slice(s) of the stream. In an opposite example case where the picture next to a picture having a degraded image quality is already inter coded prior to decoding of the next picture, the original pixel values cannot be properly decoded even if all the slices of the picture next to the lost part of the stream are properly decoded because the next picture is decoded utilizing correlation with the picture decoded immediately before, that is, the picture having the degraded image quality due to the partial loss of the stream (or because the next picture is decoded with reference to the immediately-preceding picture).

As described above, in the case where the picture next to the picture having a degraded image quality due to such a partial loss of a stream is already inter coded, the next picture cannot be properly decoded. This problem causes a further problem that the pictures following the next picture cannot be properly decoded in a recursive manner.

MPEG-2 prevents propagation of influence of image degradation due to such a partial loss of a stream by coding an I-picture including only blocks to be intra coded every time after coding a predetermined number of P-pictures. However, the number of bits of data of a coded I-picture is several to several tens of times the number of bits of data of a coded P-picture. Thus, the data is to be transmitted via a transmission bit rate smoothing device having a large buffer such that the data is transmitted through a transmission path for transmitting only data having a predetermined bit rate or less. Here, a transmission delay time produced by such a transmission bit rate smoothing device is a long time that corresponds to several to several tens of pictures. Therefore, such a transmission bit rate smoothing device is not suitable for transmitting an image signal with a short delay time. For this reason, the following method is employed to perform coding in units of a picture using an approximately the same number of bits, and thereby achieving a short delay, and preventing recursive propagation of image quality degradation.

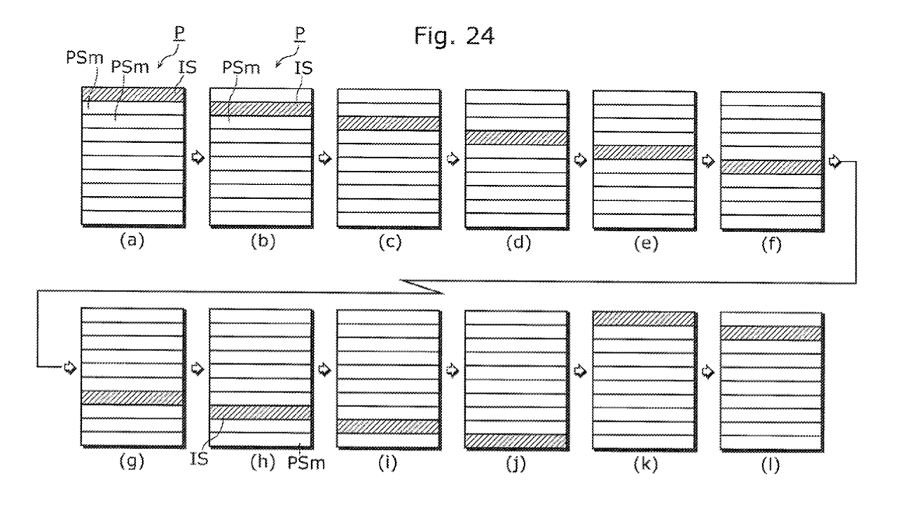

FIG. 24 is a diagram showing an example of slice division for temporally consecutive pictures ((a) to (l)).

Here, as in FIG. 22, a slice marked with diagonal lines is an I-slice IS, and each of the other slices is a P-slice PSm. Here, the slices are arranged in units of a line as in the earlier-described example. In addition, (a) to (l) in FIG. 24 are pictures that temporally consecutive to each other. In other words, in FIG. 24, (a) is the temporally first picture, and (l) is the temporally last picture. In FIG. 24, the position of a current I-slice IS shifts to the immediately-below line in the temporally next picture, and after the shift to the bottom line, the position shifts to the next top line ((j) to (k) in FIG. 24).

In this way, a picture P includes (i) an I-slice IS that is robust to a partial loss of a stream and (ii) P-slices PSm including blocks that are subjected to inter coding that yields a high compression rate as a trade off for being susceptible to such a partial loss of a stream, and the position of a current I-slice IS (the position to be set) temporally shifts in a current P-picture in a cyclic manner. Thereby, even if some part of the stream is lost at a certain time point and the image quality of the P-slice PSm degraded, the picture P is properly decoded when the slice at the position of the P-slice PSm corresponding to the lost stream portion is set as the I-slice IS in the temporally following picture. In short, the stream part at which the image quality has degraded can be reconstructed. Therefore, it is possible to prevent an infinite propagation of image quality degradation.

However, only cyclical insertion of I-slices IS is not sufficient to prevent propagation of image quality degradation.

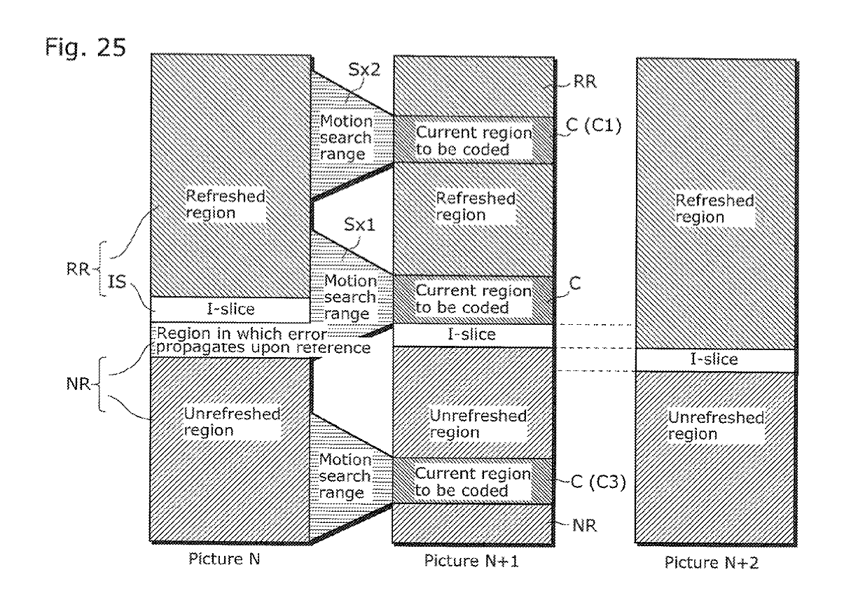

FIG. 25 is a diagram illustrating a conventional case in which no restriction is placed on motion search ranges.

Even if image quality degrades due to a partial loss of a stream, a cyclic shift of an I-slice IS stops propagation of image quality degradation (the picture is refreshed). A current I-slice IS shifts from top to bottom, and thus a picture is refreshed from top slice in sequence.

In a picture N, the pixels located at and above the current I-slice IS can be properly decoded. However, the pixels located below the current I-slice IS suffer image quality degradation. Stated differently, the pixels that suffer image quality degradation are the pixels located below the current I-slice IS in the picture N that have not yet been decoded at the time of occurrence of the image quality degradation due to the transmission error. The region in which propagation of image quality degradation is stopped by an I-slice is referred to as a refreshed region RR (See FIG. 25), and the region in which no I-slice is coded (decoded) and image quality degradation is found is referred to as an unrefreshed region NR.

The refreshed region RR is a region including an I-slice IS and slices located above the I-slice IS. Here, the positions above the I-slice IS are positions in a direction opposite to the forward direction with respect to the position at which the I-slice IS is coded (the position at which the I-slice IS is set).

An unrefreshed region NR is a region including the slices located below the I-slice IS. Here, the positions below the I-slice IS are positions in the forward direction with respect to the position at which the I-slice IS is coded.

Here, in inter coding, a current block C (the picture N+1 in FIG. 25) is compared with the pixel blocks of a comparison-target picture (the picture N in FIG. 25) in order to code differences from highly-correlated pixels in units of a block, and the differences from the pixel values of pixels at the positions at which the highest correlations are shown are coded in units of a block. Searching such pixel positions at which the highest correlations are shown is referred to as motion search. The range of positions of the blocks to be searched in this motion search in a reference picture (the picture N) is referred to as a motion search range.

When such a motion search range is within the refreshed region RR in the reference picture, a decoding apparatus performs decoding with reference to the pixel values of pixels having image quality not damaged by the transmission error, and thus the pixels inter coded and then decoded have an intact image quality.

Furthermore, even when such a motion search range is within the unrefreshed region NR, there is no problem as long as a current block C to be coded of the picture N+1 is within the unrefreshed region NR (the current block C3 to be coded). This is because the decoding apparatus stops image quality degradation due to the transmission error when decoding, as an I-slice, a slice located at the position of the current block C3 to be coded with reference to a following picture (such as the picture N+2 etc.)

A problem occurs in the case where a current block to be coded of the picture N+1 is a block (the current block C1 to be coded) in the refreshed region RR but coding is performed with reference to the unrefreshed region NR of the picture N. In this case, the decoding apparatus cannot decode the block in the following picture (see the picture N+2) using the (intra coded) I-slice. This causes a problem that the image quality degradation due to the transmission error cannot be solved in the decoding of the block and decoding with reference to the block. In other words, the image quality degradation propagates when reference to a block in the unrefreshed region NR of the reference picture (the picture N) is made from a block of the refreshed region RR of the current picture to be coded (the picture N+1).

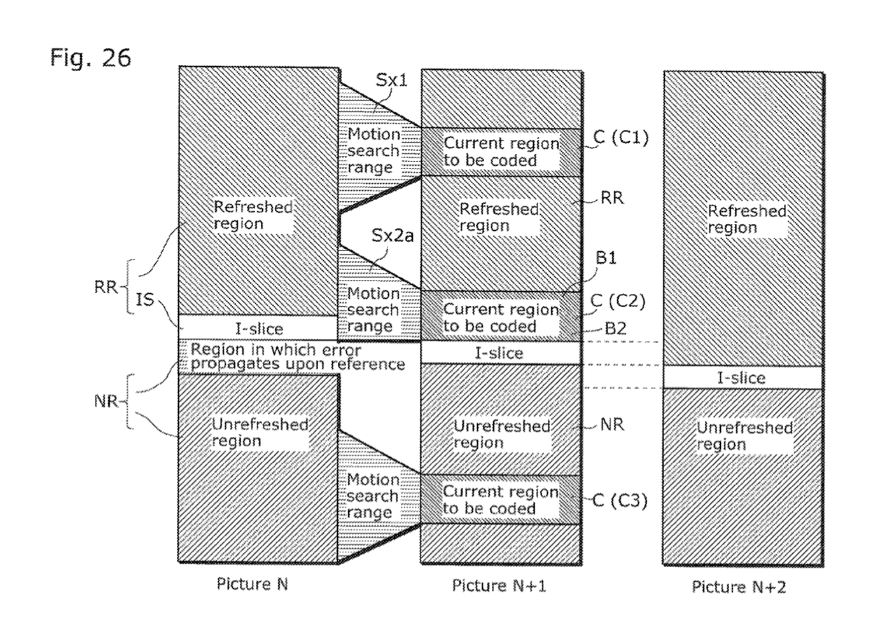

FIG. 26 is a diagram showing processing performed in the case of limiting search ranges.

One known schemes to prevent this includes, as shown in FIG. 26, a scheme of stopping propagation of image quality degradation due to transmission error by determining, as a motion search range, a refreshed region RR (the region at which coding using an I-slice has already been completed) in the picture N in coding the blocks (the current blocks C1 and C2 to be coded) in the refreshed region RR of the picture N+1.

The technique disclosed in PTL 1 is an example of such conventional techniques.

### CITATION LIST

### Patent Literature

### [PTL 1]

Japanese Unexamined Patent Application Publication No. 2008-258953

### SUMMARY OF INVENTION

### Technical Problem

However, the above-described conventional coding methods must involve dynamically limiting motion search ranges such that the motion search ranges do not include any unrefreshed region NR in motion search for coding the blocks of a refreshed region RR. Stated differently, there is a need to perform such motion search while changing the sizes of the motion search ranges according to the position of coding (the position of a current block C to be coded). For example, in FIG. 26, motion search ranges different from the motion search ranges used for the motion search in a block B2 are used for the motion search in a block B1. For this reason, the conventional coding methods entail a problem of complexity in control. For example, the sizes of the motion search ranges change depending on the position, which results in change in time required for motion search processing. This increases complexity in control to perform pipeline processing for motion search, and thereby necessitating complex circuits. This decreases the processing speed, disabling processing of high-resolution data at a required speed. For example, high-vision data cannot be properly processed.

The present invention, which has been conceived to solve the above-described problems, has an object to provide moving picture coding apparatuses which prevent error propagation by avoiding making reference to a block in an unrefreshed region without dynamically limiting motion search ranges, and to provide such moving picture coding methods, and the like. Stated differently, the present invention achieves prevention of error propagation from an unrefreshed region to a refreshed region by performing simple processing, or by using simply-configured apparatuses. Furthermore, the present invention has an object to provide apparatuses which properly process even high-resolution data such as high-vision data.

### Solution to Problem

In order to achieve the above object, a coding method according to the present invention is intended to code pictures each including an I-slice and P-slices such that a position of a current I-slice that is set for a current picture to be coded among the pictures is shifted in a vertical direction of the current picture, and the coding method includes: performing first inter coding, without using a motion vector, on one or more first P-slices in a first region in the current picture, the first region being adjacent to the current I-slice in a direction opposite to a forward direction for the shift in the vertical direction; and performing second inter coding, using a motion vector, on a second P-slice in a second region that is other than the first region within the current picture.

When an I-slice and P-slices are included in a picture, the picture including the I-slice also includes the P-slices.

It is also possible to stop motion search for slices which are located above a current I-slice and on which a refresh is performed.

### Advantageous Effects of Invention

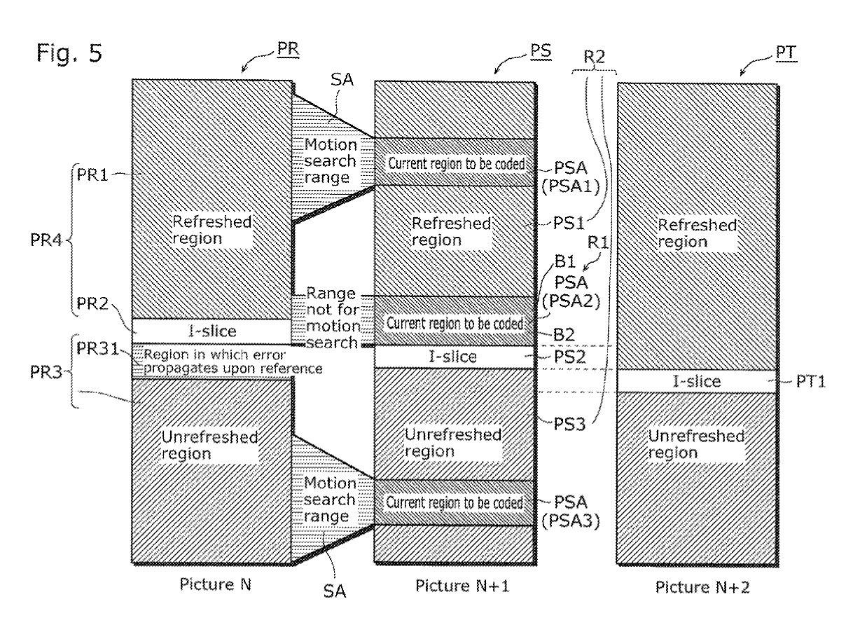

According to the present invention, as shown in FIG. 5, it is possible to disable a motion search function in the P-slices located above the I-slice without performing complex processing of dynamically limiting motion search ranges. Decoding I-slices in following pictures while performing such simple processing makes it possible to properly decode a picture having a degradation-free image quality even when some part of the stream has been lost during transmission via a network. Here, a first P-slice region is located at the bottom portion of the refreshed region adjacent to the I-slice in a direction opposite to the forward direction for the shift. This bottom portion is inter coded using a co-located image without using any motion vector, that is, without considering any motion. In this way, it is possible to prevent reference to a block in the unrefreshed region (the region adjacent in the forward direction for the shift with respect to the I-slice) in the reference picture. This makes it possible to prevent image quality degradation propagation from the unrefreshed region to the refreshed region. The processing performed is simple because a co-located image is simply used. In this way, it is possible to achieve both prevention of undesirable image quality degradation propagation and simplification of processing performed.

### BRIEF DESCRIPTION OF DRAWINGS

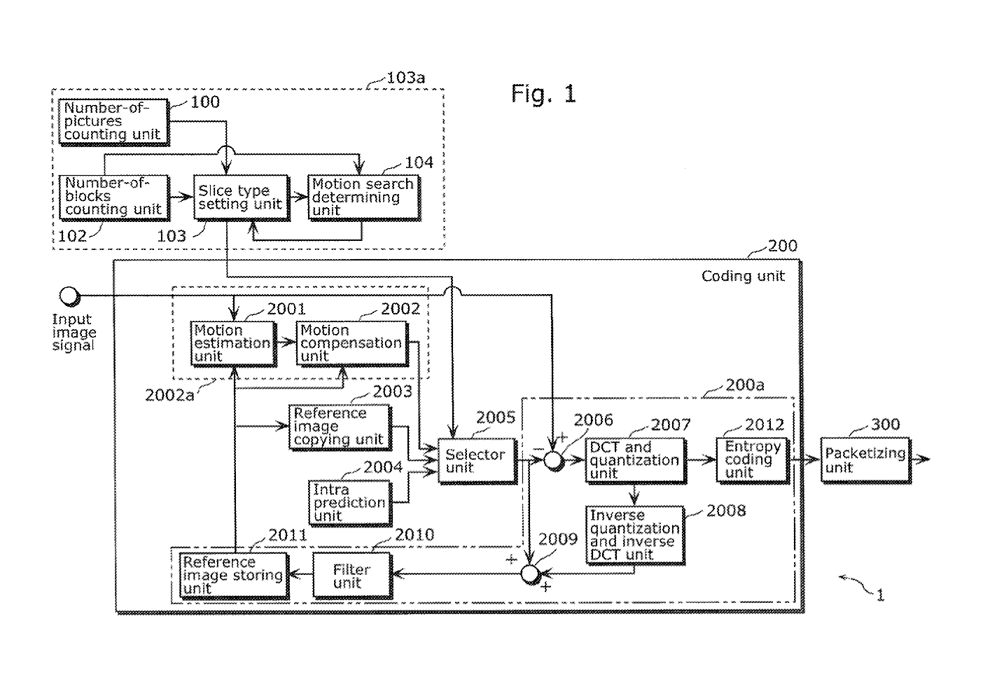

### [FIG. 1]

FIG. 1 is a block diagram of a moving picture coding apparatus according to Embodiment 1.

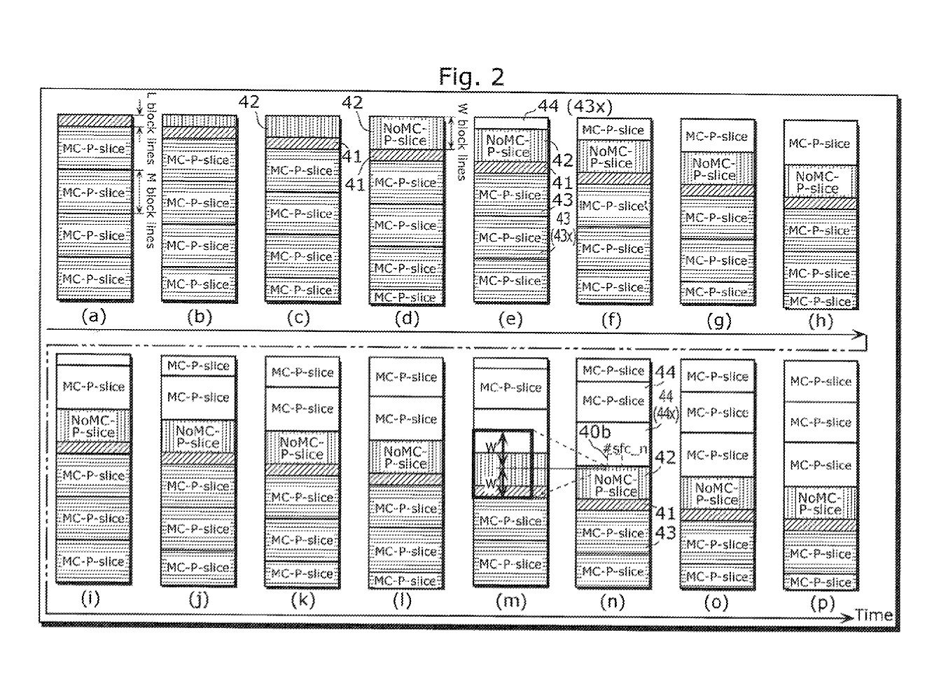

### [FIG. 2]

FIG. 2 is an illustration of relationships between slice division schemes and reference in Embodiment 1.

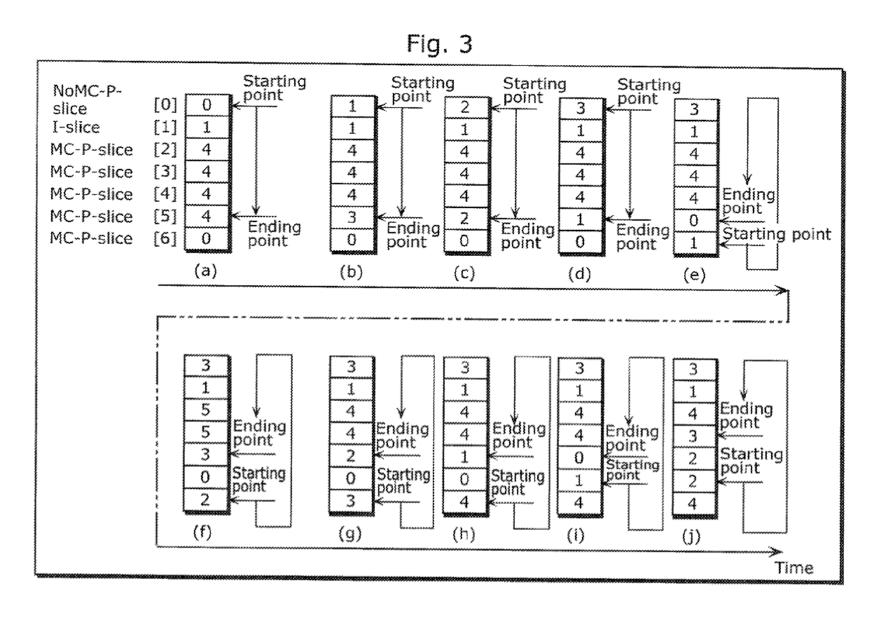

### [FIG. 3]

FIG. 3 is an illustration of operations of slice division and slice type determination in Embodiment 1.

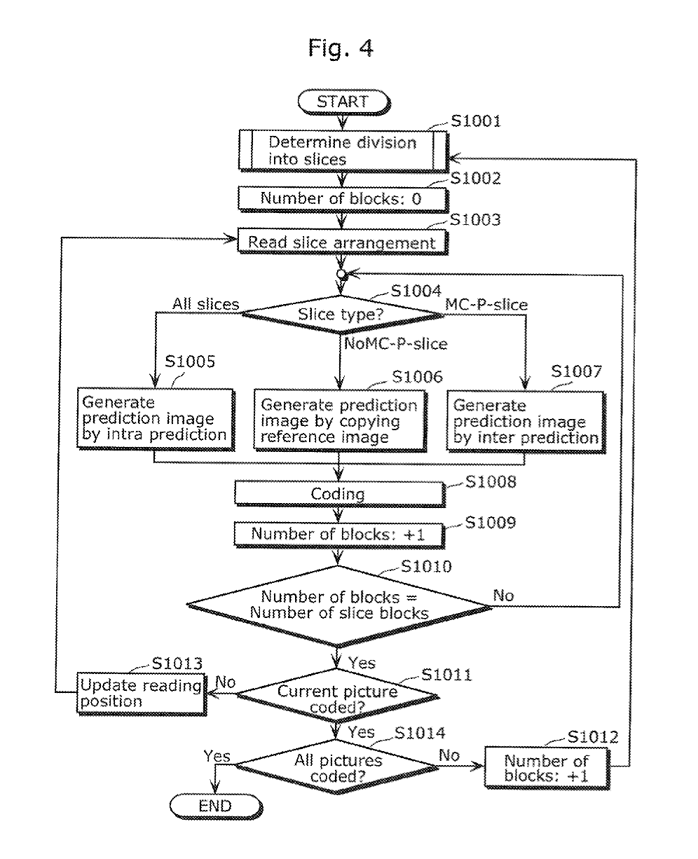

### [FIG. 4]

FIG. 4 is a flowchart illustrating operations in Embodiment 1.

### [FIG. 5]

FIG. 5 is a diagram illustrating restrictions placed on motion search ranges according to the present invention.

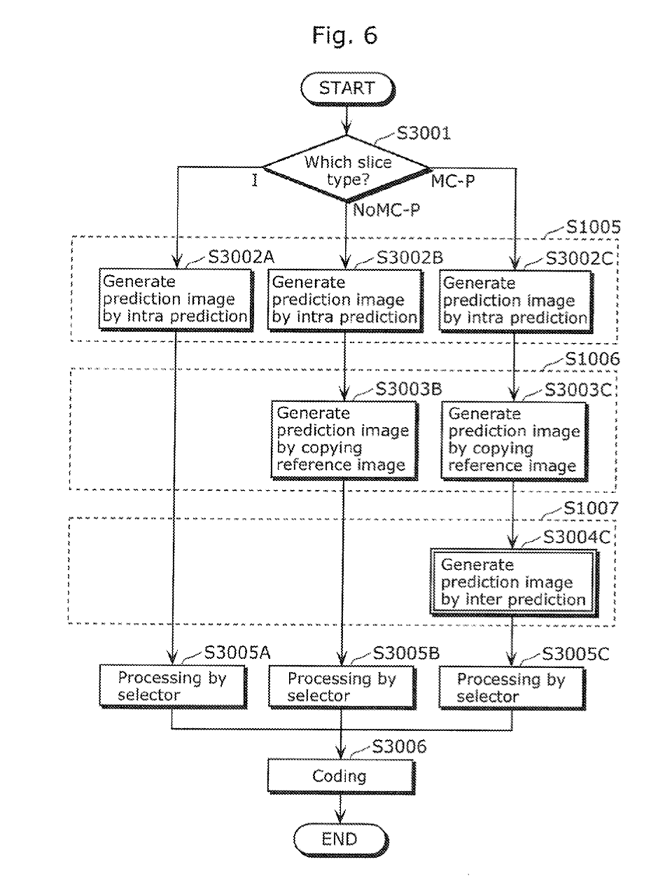

### [FIG. 6]

FIG. 6 is a flowchart of processes performed according to the types of slices.

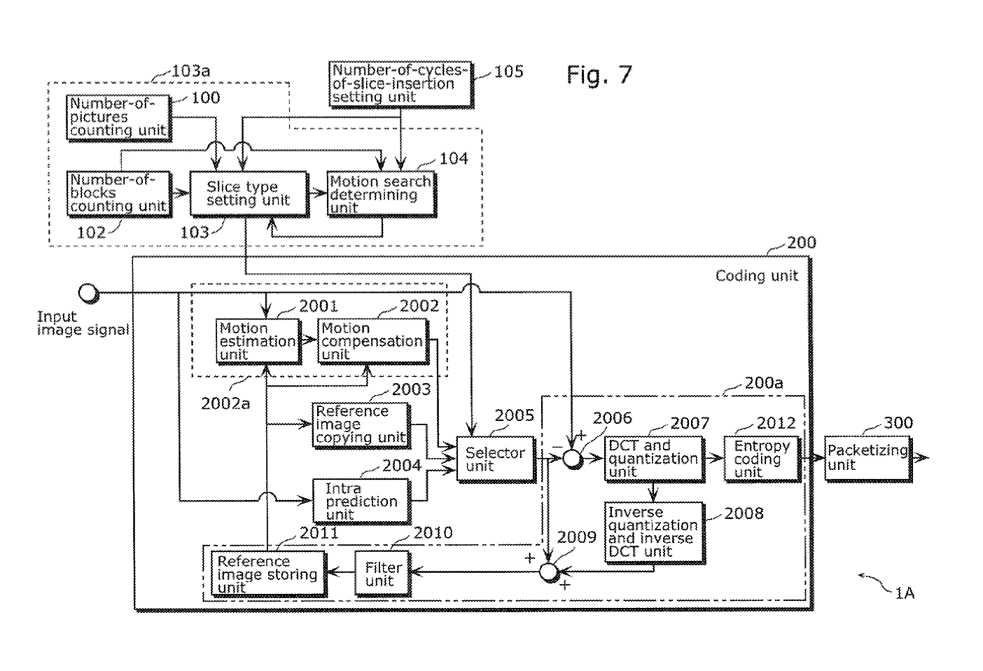

### [FIG. 7]

FIG. 7 is a block diagram of a moving picture coding apparatus according to Embodiment 2.

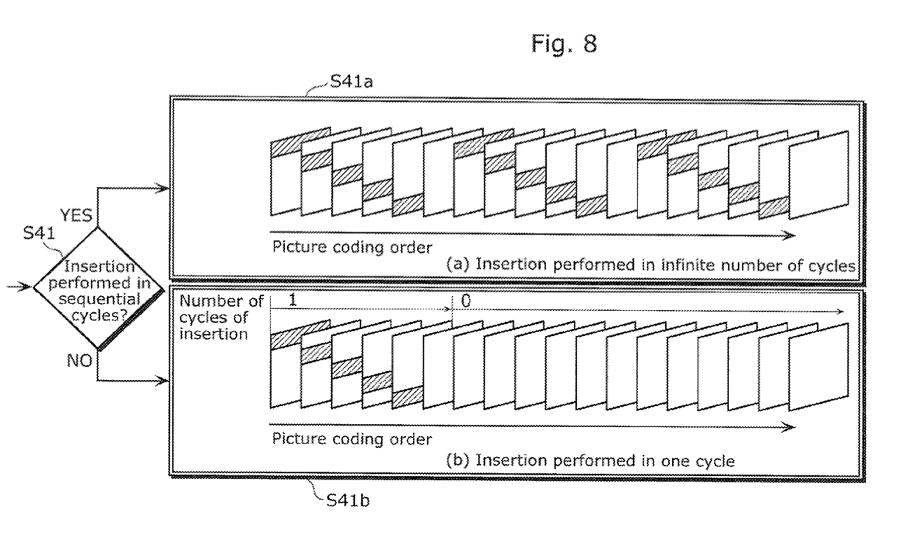

### [FIG. 8]

FIG. 8 is a diagram showing an example of a difference in the number of cycles of I-slice insertion in Embodiment 2.

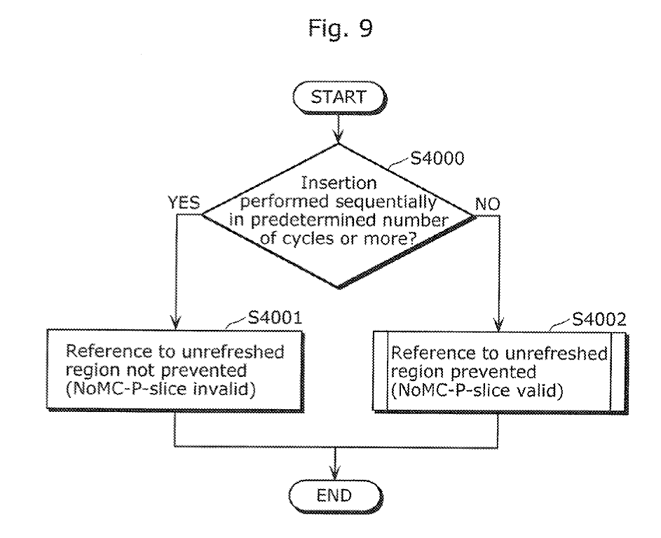

### [FIG. 9]

FIG. 9 is a flowchart of processes performed by a moving picture coding apparatus 1A.

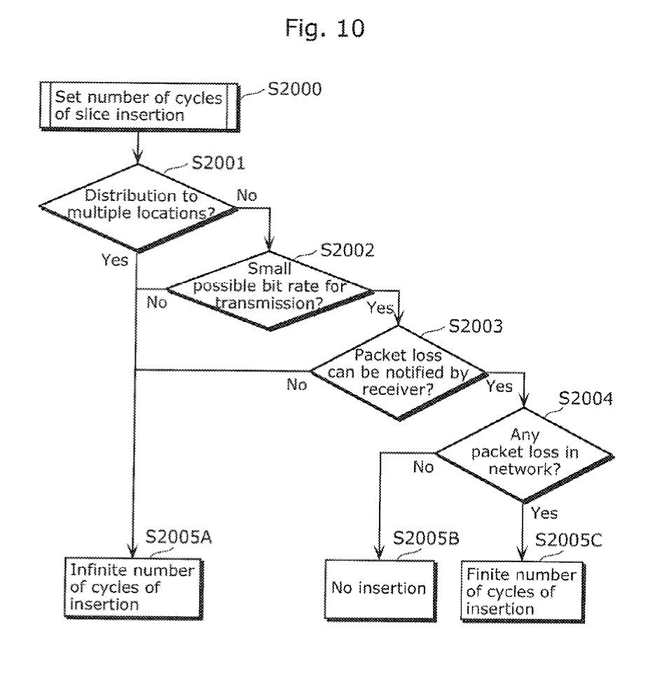

### [FIG. 10]

FIG. 10 is a flowchart of processes performed by a number-of-cycles-of-slice-insertion setting unit in Embodiment 2.

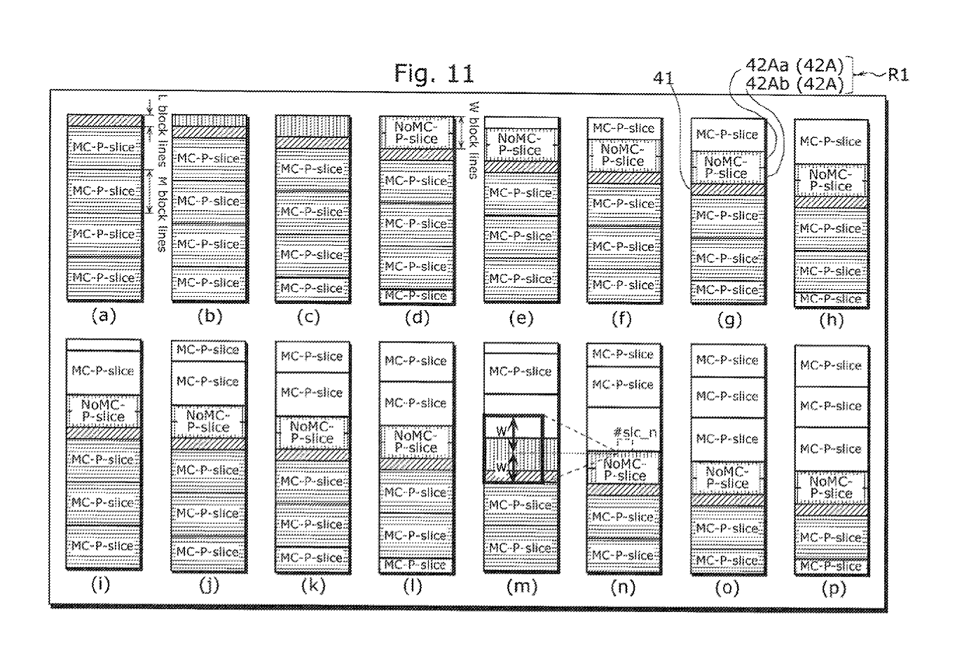

### [FIG. 11]

FIG. 11 is an illustration of relationships between slice division schemes and reference in Embodiment 3.

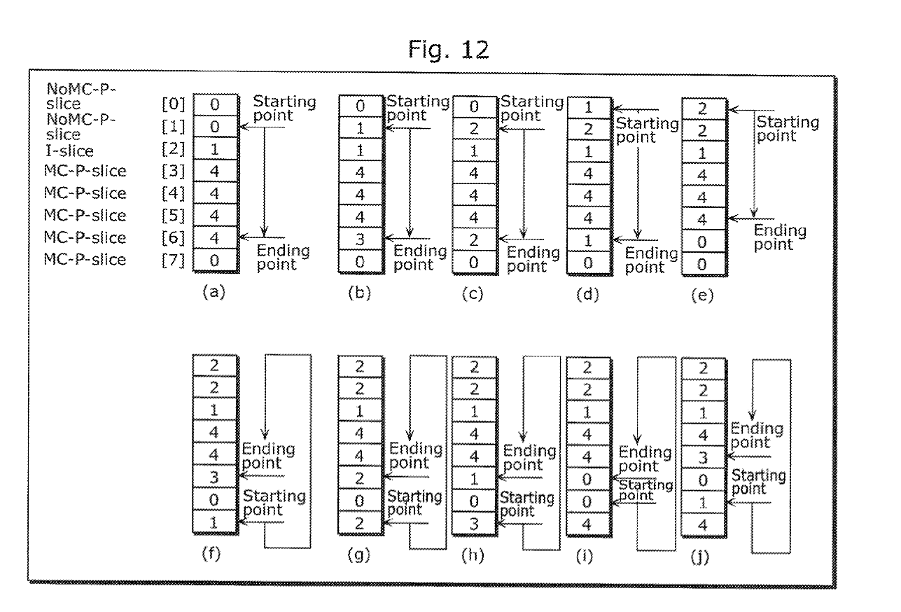

### [FIG. 12]

FIG. 12 is an illustration of operations of slice division and slice type determination in Embodiment 3.

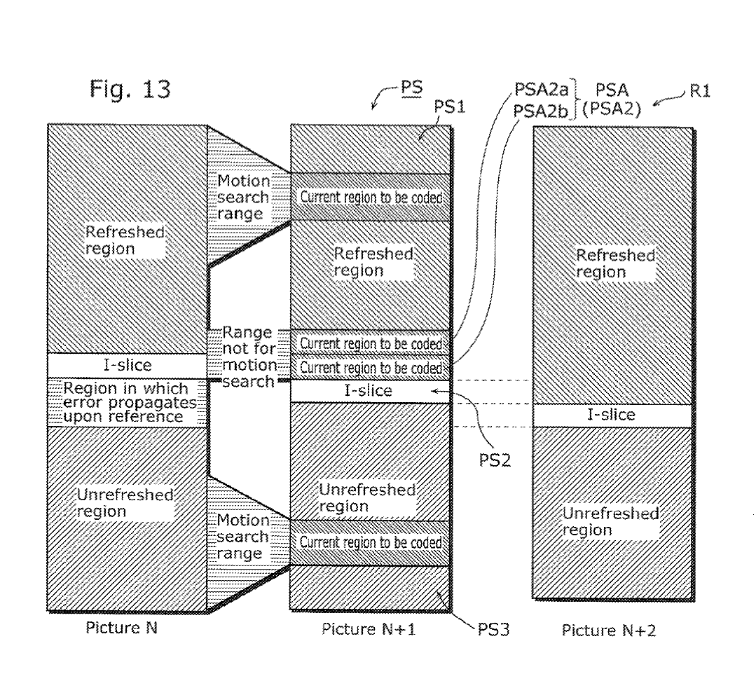

### [FIG. 13]

FIG. 13 is a diagram illustrating restrictions placed on motion search ranges in Embodiment 3.

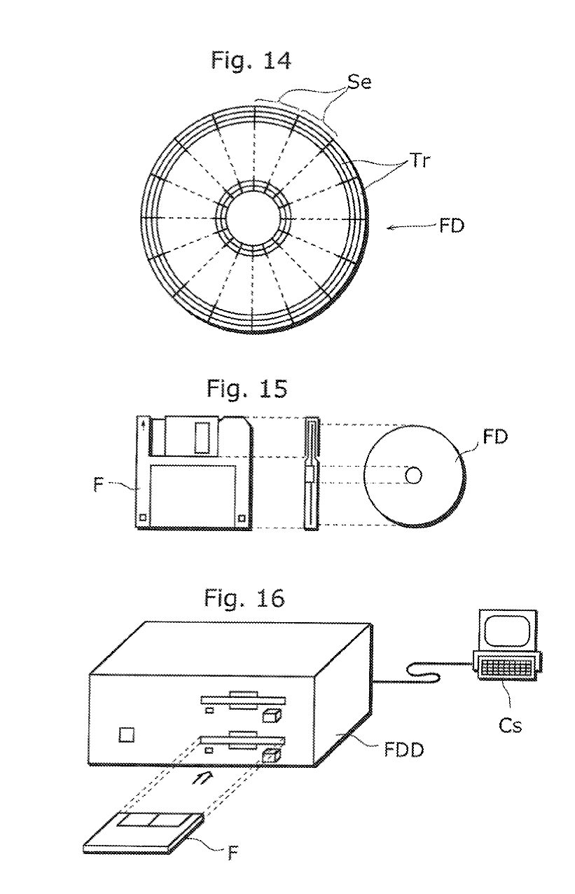

### [FIG. 14]

FIG. 14 is an illustration of a recording medium for storing a program for implementing the moving picture coding apparatus of each embodiment in a computer system.

### [FIG. 15]

FIG. 15 is an illustration of a recording medium for storing a program for implementing the moving picture coding apparatus of each embodiment in a computer system.

### [FIG. 16]

FIG. 16 is an illustration of a recording medium for storing a program for implementing the moving picture coding apparatus of each embodiment in a computer system.

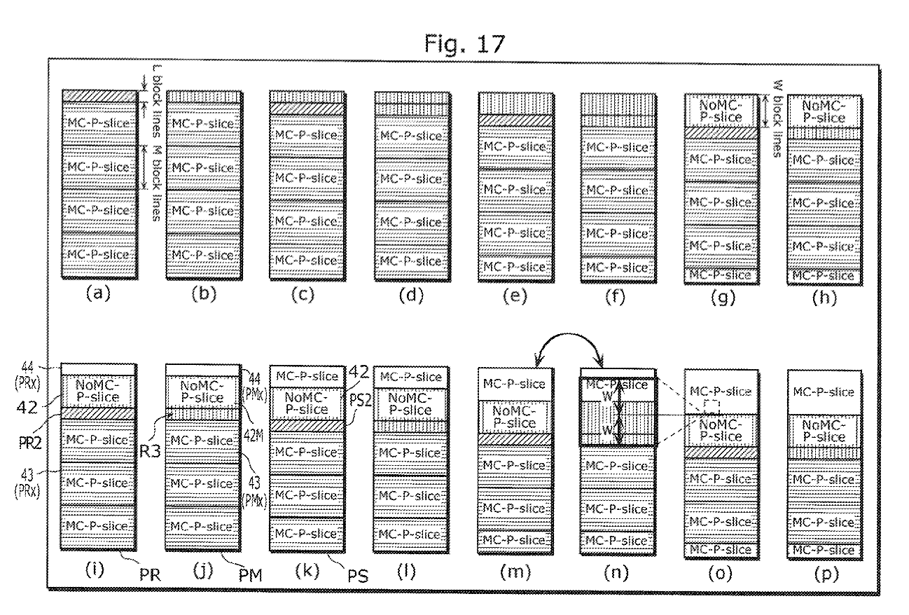

### [FIG. 17]

FIG. 17 is a diagram showing plural pictures.

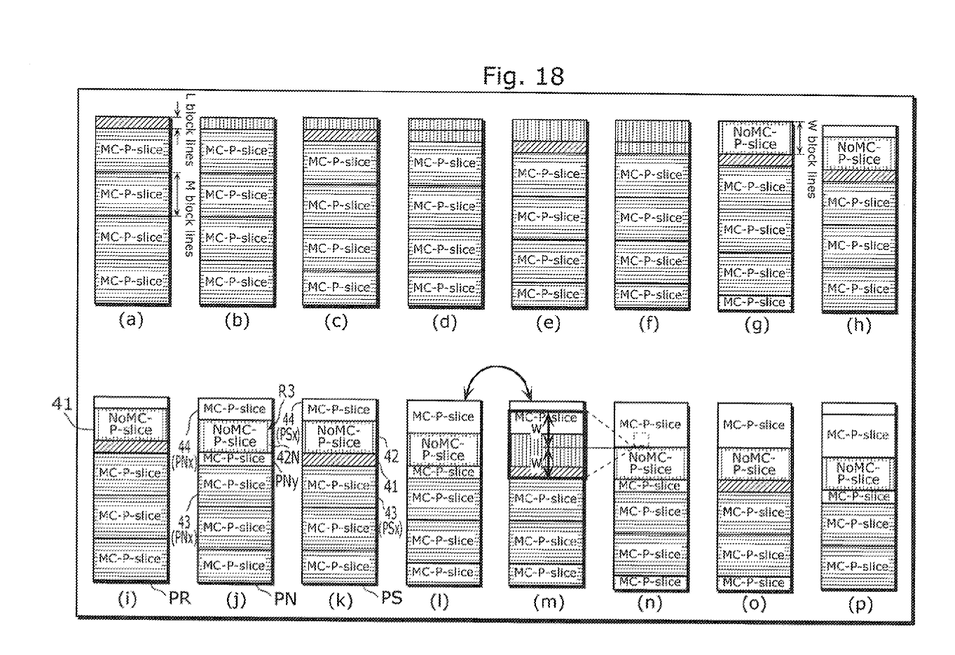

### [FIG. 18]

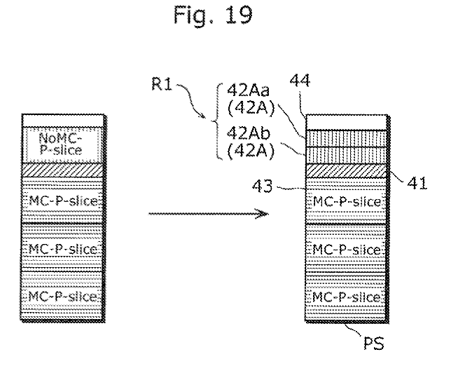

FIG. 18 is a diagram showing plural pictures.

[FIG. 19]

FIG. 19 is a diagram showing plural NoMC-P-slices.

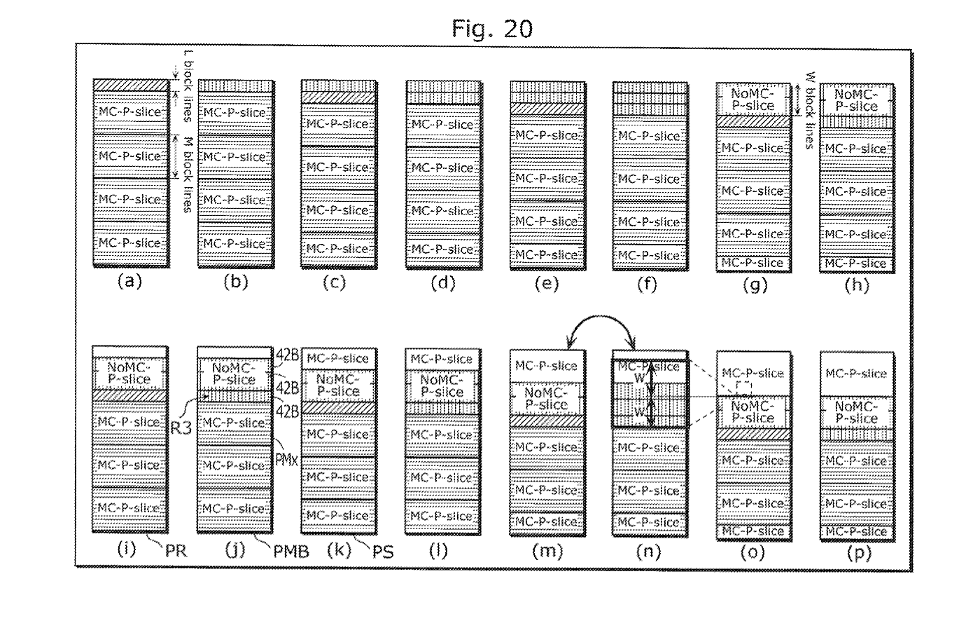

### [FIG. 20]

FIG. 20 is a diagram showing plural pictures.

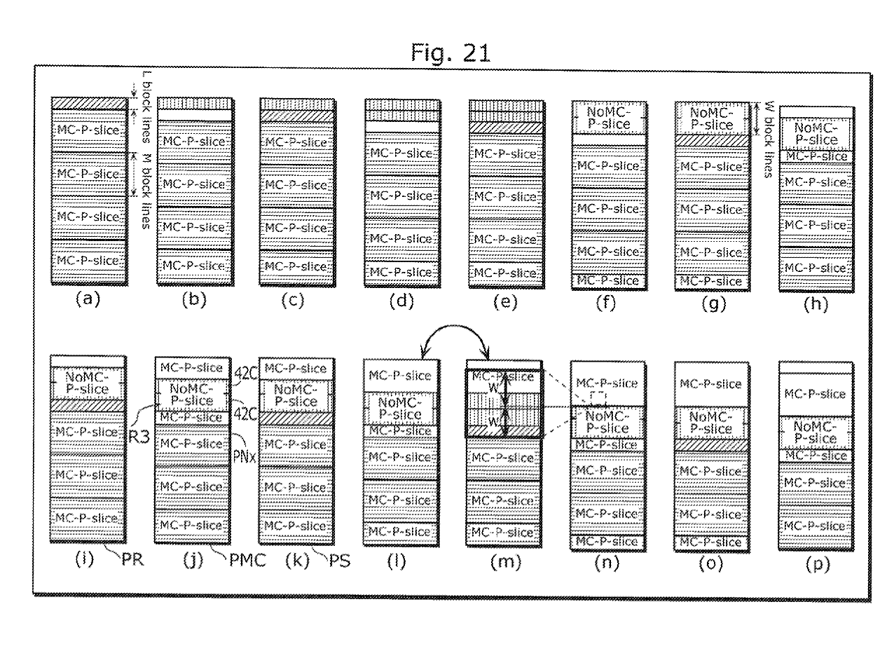

### [FIG. 21]

FIG. 21 is a diagram showing plural pictures.

### [FIG. 22]

FIG. 22 is an illustration showing relationships between slices and blocks in MPEG.

### [FIG. 23]

FIG. 23 is an illustration of a coding order of plural blocks in a picture.

### [FIG. 24]

FIG. 24 is a diagram showing an example of slice division for temporally consecutive pictures.

### [FIG. 25]

FIG. 25 is a diagram illustrating a conventional case in which no restriction is placed on motion search ranges.

### [FIG. 26]

FIG. 26 is a diagram illustrating conventional restrictions placed on motion search ranges.

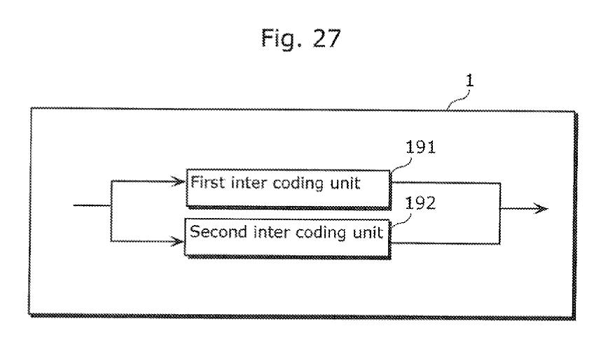

### [FIG. 27]

FIG. 27 is a block diagram of a moving picture coding apparatus.

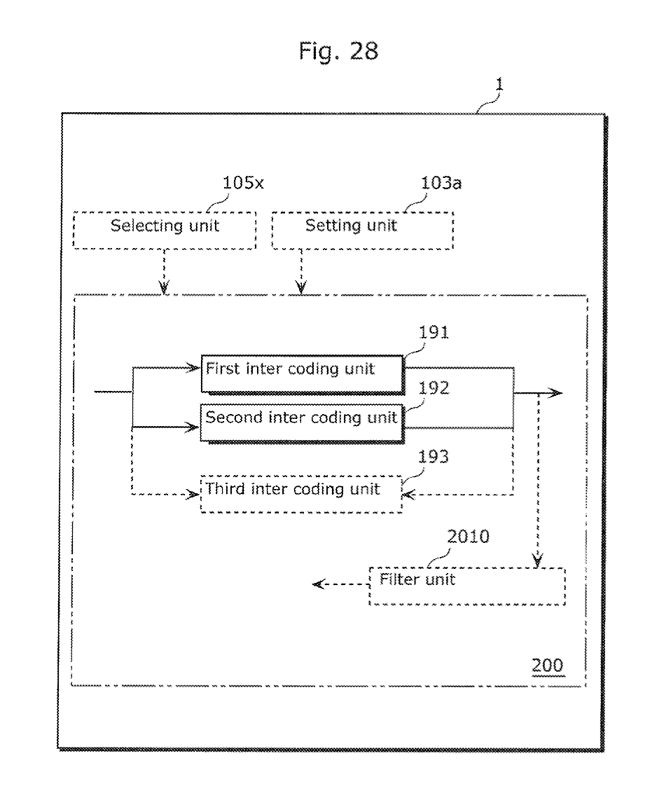

### [FIG. 28]

FIG. 28 is a block diagram of a moving picture coding apparatus.

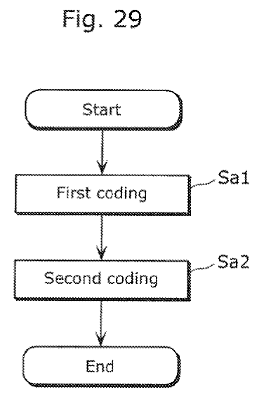

### [FIG. 29]

FIG. 29 is a flowchart of processing performed by a moving picture coding apparatus.

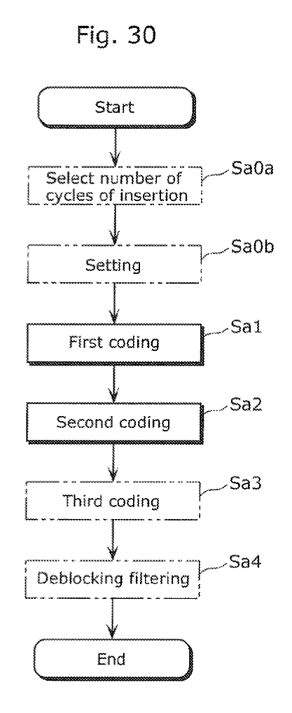

### [FIG. 30]

FIG. 30 is a flowchart of processing performed by a moving picture coding apparatus.

### DESCRIPTION OF EMBODIMENTS

Embodiments according to the present invention are described below with reference to the drawings.

A moving picture coding method (A1) according to an embodiment of the present invention is intended to code pictures each (a current picture PS to be coded in FIG. 5, a reference picture PR, a following picture PT, etc.) including an I-slice (I-slice PR2, I-slice 41 in FIG. 2) and P-slices (a slice in a current region PSA, a NoMC-P-slice 42 in FIG. 2, MC-P-slice 43) such that a position of a current I-slice that is set for a current picture to be coded among the pictures is shifted in a vertical direction of the current picture (the downward direction in FIG. 5), and the moving picture coding method includes: performing first inter coding (S3001: process for a NoMC-P-slice), without using a motion vector, on one or more first P-slices (NoMC-P-slices 42) in a first region in the current picture, the first region being adjacent to the current I-slice in a direction opposite to a forward direction for the shift in the vertical direction (more specifically, the first region included in the refreshed region PS1 (located at the upper side in FIG. 5) is adjacent to the I-slice PS2) and the first region (first P-slice region) being first region R1 (FIG. 5), first P-slice region, NoMC-P-slice 42 region, and current region PSA2, the first P-slice being included in the first region R1, etc. (i) that is included in the refreshed region PS1, and (ii) has a search range (see the search range S×1 in FIG. 25) for the first region that is overlapped with the unrefreshed region PR3), and the first inter coding being performed by coding a difference from the second prediction image with reference to the second prediction image co-located with the current block to be coded; and performing second inter coding (S3001: process for an MC-P-slice), using a motion vector, on a second P-slice (MC-P-slice 44, MC-P-slice 43) in a second region that is other than the first region (the first P-slice region) within the current picture, the second region being the second region R2, the second P-slice region, the MC-P-slice 44, and the MC-P-slice 43 (MC-P-slice 43x), and the second inter coding being performed with reference to the second prediction image searched within the search region (the second prediction image is located at the position identified by a motion vector obtained in the search).

A first region (the first region R1) is also referred to as a first P-slice region as necessary, and a second region (the second region R2) is also referred to as a second P-slice region as necessary.

In short, the first region R1 is a region within a predetermined range located above the I-slice 41 in a current picture PS to be coded (for example, (e) in FIG. 2). This range will be described in detail later.

In the second coding process, the blocks included in the current picture PS to be coded ((e) in FIG. 2, for example) are subjected to coding with reference to an image (a second prediction image) that is searched in a search range of a reference picture ((d) in FIG. 2, picture PR).

More specifically, in the second process, such coding is performed only when a current block is not a block in a NoMC-P-slice 42 in a first region R1, and such coding is not performed when a current block is a block in the NoMC-P-slice 42 (a first inter coding unit 191 in FIG. 27, Step Sa1 in FIG. 29).

In the first coding process, a block in the current picture PS is subjected to coding with reference to an image (a first prediction image) that is of the reference picture PR ((d) in FIG. 2) and is co-located with the current block of the current picture PS.

More specifically, in the first coding process, such coding is not performed when a current block is not a block in an MC-P-slice 43x (FIG. 2) in the first region R1, and such coding is performed only when a current block is a block in the NoMC-P-slice 42 (a first inter coding unit 191, Step Sa1).

In other words, a conventional example performs search using mutually different search ranges (see a search range Sx2a in FIG. 26) for mutually different blocks (such as blocks B1 and B2 in FIG. 26) in the first region. This necessitates complex circuits, resulting in complex configuration and slow processing speeds.

In contrast, a moving picture coding method according to the present invention prevents that co-located first prediction images are simply used for search performed for the respective mutually different blocks (such as the blocks B1 and B2 in FIG. 5) in the first region. Since search using mutually different search ranges is prevented in this way, it is possible to simplify circuit configuration because no complex circuits are required, and to increase the processing speed.

This makes it possible to prevent image quality degradation propagation from an unrefreshed region to a refreshed region, and concurrently to achieve a simple configuration (fast processing speeds).

Here, since the position of a current I-slice shifts, the positions of I-slices in plural pictures are different from picture to picture. The first P-slice region is a particular region that is described later. The particular region is a region which is in a refreshed region (refreshed region PS1) in a current picture (current picture PS) and which has a distance from an unrefreshed region (unrefreshed region PR3) in a reference picture (reference picture PR) which is not greater than a predetermined distance. Stated differently, this region is the region (the later-described particular region, NoMC-P-slice 42 region) which is of the region having the distance not greater than the predetermined distance and is other than the I-slice within the current picture. The vertical width of the first P-slice region corresponds to a predetermined size that is larger than 0. The direction opposite to the forward direction for the shift in the vertical shifting direction is a direction from the I-slice (I-slice PR2) to a refreshed region. When a slice is adjacent in the opposite direction means the slice is adjacent to the I-slice from the direction.

In this way, with this structure, inter coding is performed, without using any motion vector, on the image of a slice in the particular region in which image quality degradation may be propagated from an unrefreshed region to a refreshed region.

More specifically, the moving picture coding method in this embodiment may further include performing third inter coding (Sa3, the third inter coding unit 193), using a motion vector, on another one of the first P-slices in the first region (the first P-slice region), wherein, the third inter coding may be performed, using the motion vector, on the other one of the first P-slices in the first region (the first P-slice region) when an I-slice is inserted repeatedly (S41: YES, S4000: YES, in the case of a predetermined number of cycles or a larger, number of cycles in S2005A, S2005C) and in the performing first inter coding, the first inter coding may be performed, without using a motion vector, on the one or more first P-slices in the first region (the first P-slice region) when I-slices are inserted only in a predetermined number of cycles (S41: NO, S4000: NO, in the case of a predetermined number of cycles or a smaller number of cycles in S2005A, S2005C).

For example, repeatedly inserting an I-slice means inserting I-slices in the number of insertion cycles which is equal to or larger than a threshold value. Likewise, inserting an I-slice (only) a predetermined number of times means inserting I-slices in the number of insertion cycles which is not larger than the threshold value.

A moving picture coding apparatus in this embodiment is a moving picture coding apparatus 1 which (i) executes the above-described moving picture coding method and (ii) is intended to code pictures each including an I-slice and P-slices such that a position of a current I-slice that is set for a current picture to be coded among the pictures is shifted in a vertical direction of the current picture, and the moving picture coding apparatus 1 includes: a slice type determining unit (slice type setting unit 103, setting unit 103a, Sa0b) configured to determine slice types of the P-slices, so that first inter coding is performed, without using a motion vector, on one or more first P-slices in a first region in the current picture, the first region being adjacent to the current I-slice in a direction opposite to a forward direction for the shift in the vertical direction, and second inter coding is performed, using a motion vector, on a second P-slice in a second region that is other than the first region within the current picture; a first inter coding unit (reference image copying unit 2003) configured to perform the first inter coding, without using a motion vector, on the one or more first P-slices in the first region; and a second inter coding unit (search unit 2002a) configured to perform the second inter coding, using a motion vector, on the second P-slice in the second region.

In this way, the moving picture coding method is executed, thereby achieving simplification of processing performed and prevention of undesirable image quality deterioration propagation.

For example, a determination may be made as to whether or not a current block is of the NoMC-P-slice 42 in the first region R1. It is also good to perform control far causing the second coding unit to code the current block when it is determined that the current block is not of the NoMC-P-slice 42, and perform control for causing the first coding unit to code the current block when it is determined that the current block is of the NoMC-P-slice 42 (a setting unit 103a, Step Sa0b in FIG. 30).

The moving picture coding apparatus in this embodiment may include a number-of-cycles-of-slice-insertion setting unit (a number-of-cycles-of-slice-insertion setting unit 105, Sa0a) configured to determine whether or not the number of cycles of insertion of I-slices is equal to or larger than a predetermined value, wherein the slice type determining unit may be configured to determine that the slice types of the P-slices indicate the one or more first P-slices included in the first region (the first P-slice region) and the second slice included in the second region (the second P-slice region) when the number-of-cycles-of-slice-insertion setting unit determines that the number of cycles of insertion is not larger than the predetermined value (S41: NO, S4000: NO, in the case of a smaller-than-predetermined number of cycles in S2005C), and determine that the slice types of the P-slices indicate second P-slices (the second P-slice regions) included in the second region when the number-of-cycles-of-slice-insertion setting unit determines that the number of cycles of insertion is equal to or larger than the predetermined value (S41: YES, S4000: YES, in the case of a predetermined number of cycles or a larger number of cycles in S2005C, S2005A).

In this way, it is possible to prevent that the earlier-described moving picture coding method A1 is executed even when the number of cycles of I-slice insertion is equal to or larger than the predetermined value. Here, when the number of cycles of insertion is large, each insertion after occurrence of undesirable image quality degradation propagation generally suppress the influence of such propagation, and thus such image quality degradation due to the propagation disappears in short time. For this reason, image quality is unlikely to degrade even if the method A1 is not executed. In the case of not executing the method A1, it is possible to perform inter coding using motion vectors, and thereby reducing the amount of coded data. Therefore, it is possible to reduce the amount of coded data more significantly maintaining high image quality.

### Embodiment 2

### (Structure)

FIG. 1 is a block diagram showing a structure of a moving picture coding apparatus 1 in Embodiment 1 according to the present invention.

A number-of-pictures counting unit 100 counts the number of pictures to be coded. In addition, the number-of-pictures counting unit 100 notifies a slice type setting unit 103 of the number of pictures.

A number-of-blocks counting unit 102 counts the number of blocks in the picture to be coded. Furthermore, the number-of-blocks counting unit 102 notifies the slice type setting unit 103 of the number of blocks.

A motion search determining unit 104 receives a notification about a slice type from the slice type setting unit 103. In the case where the notified slice type is a P-slice, the motion search determining unit 104 determines whether the current slice to be coded is an MC-P-slice (a first P-slice) subjected to motion prediction or a NoMC-P-slice (a second P-slice) not subjected to motion search. The motion search determining unit 104 notifies the slice type setting unit 103 of an identification of either I-slice, MC-P-slice, or NoMC-P-slice.

The slice type setting unit 103 determines whether the current slice that is to be coded by a coding unit 200 is an I-slice or a P-slice, based on the number of blocks notified by the number-of-blocks counting unit 102. The slice type setting unit 103 notifies a motion search determining unit 104 of the determined slice type.

In the case where the determined slice type is a P-slice, the slice type setting unit 103 receives the identification of either MC-P-slice or NoMC-P-slice from the motion search determining unit 104.

The slice type setting unit 103 determines the position of the I-slice, the position of the NoMC-P-slice, the position and height of the P-slice within the picture, based on the height of the image, the height of the I-slice, the height of the P-slice, and the height of the search range in motion search.

Furthermore, when the number of pictures notified by the number-of-pictures counting unit 100, the slice type setting unit 103 determines a slice division position obtained by lowering, by the width of an I-slice, the setting position for a current I-slice.

The slice type determined by the slice type setting unit 103 is notified by the slice type setting unit 103 to each of a motion estimation unit 2001, a motion compensation unit 2002, a reference image copying unit 2003, an intra prediction unit 2004, and a selector unit 2005 which are inside the coding unit 200. The motion estimation unit 2001 and the motion compensation unit 2002 are referred to as a search unit 2002a as a whole.

The intra prediction unit 2004 predicts an input image signal (a pixel value), based on an already coded pixel (not shown) within the same picture, and outputs the predicted pixel value as a prediction image (third prediction image) to the selector unit 2005.

For example, the intra prediction unit 2004 may perform such prediction, based on only the pixel in a certain slice in a prediction image from among the pixels within the same picture. For example, the intra prediction unit 2004 may identify, as an appropriate prediction image, the image located at the position closest to the position of the prediction image from among the images located at plural positions in the slice, and determine the identified image as a third prediction image.

The motion estimation unit 2001 searches the pixel position having the highest correlation with the input image signal, and notifies the motion compensation unit 2002 of the position (motion vector).

The motion compensation unit 2002 reads the pixel value of the pixel including the motion vector notified by the motion estimation unit 2001, from the reference image held by the reference image storing unit 2011, and outputs it as a prediction image (second prediction image) to the selector unit 2005.

The reference image copying unit 2003 outputs the image located at the block position held by the reference image storing unit 2011 as a prediction image (first prediction image) to the selector 2005.

In this way, as examples, the first prediction image may be output by the reference image copying unit 2003, the second prediction image may be output by the motion compensation unit 2002, and the third prediction image may be output by the intra prediction unit 2004.

To put it differently, for example, the third prediction image is a prediction image that is used by the moving picture coding apparatus 1 to perform only spatial compression from among spatial compression and temporal compression. The second prediction image is a prediction image for performing both kinds of the compression. The first prediction image is a prediction image for performing only temporal compression. The third prediction image is, for example, a prediction image for intra coding an image. The second prediction image is, for example, a prediction image for inter coding an image.

The selector unit 2005 receives a notification of the slice type (either I-slice, MC-P-slice, or NoMC-P-slice) from the slice type setting unit 103. When the notified slice type is I-slice, the selector unit 2005 selects the prediction image (third prediction image) generated by the intra prediction unit 2004.

When the notified slice type is MC-P-slice, the selector unit 2005 selects the prediction image having the smallest number of coded bits from among the prediction images (the third prediction image and the second prediction image) generated by the intra prediction unit 2004 and the motion compensation unit 2002.

When the notified slice type is NoMC-P-slice, the selector unit 2005 selects the prediction image yielding the smallest number of bits required for coding from among the prediction images (the third prediction image and the first prediction image) generated by the intra prediction unit 2004 and the reference image copying unit 2003. When the notified slice type is MC-P-slice, the selector unit 2005 may select, for example, one of the first prediction image, the second prediction image, and the third prediction image.

A subtractor 2006 performs subtraction between the input image and a prediction image (selected prediction image) selected by the selector unit 2005, and outputs a prediction error (post-subtraction image).

A DCT and quantization unit 2007 performs transform (orthogonal transform) from time domain to frequency domain and quantization on the prediction error (post-subtraction image), and outputs the quantized value to each of the entropy coding unit 2012 and an inverse quantization and inverse DCT unit 2008.

The inverse quantization and inverse DCT unit 2008 performs inverse quantization and inverse transform from frequency domain to time domain on the quantized value output from the DCT and quantization unit 2007, and outputs the difference image.

An adder 2009 adds the prediction image (selected prediction image) output from the selector unit 2005 and the difference image output from the inverse quantization and inverse DCT unit 2008 to generate a reconstructed image.

The filter unit 2010 applies a deblocking filter for removing block distortion to the reconstructed image output from the adder 2009.

The reference image storing unit 2011 stores the image output from the filter unit 2010 in, for example, a memory such as a memory that constitutes at least a part of the reference image storing unit 2011. The image held therein is referred to as a reference image by each of the motion estimation unit 2001, the motion compensation unit 2002, and the reference image copying unit 2003.

The filter unit 2010 is required in H.264, but is not required in image coding in MPEG-1, MPEG-2, MPEG-4, and the like.

The entropy coding unit 2012 converts the quantized value, which is an output by the DCT and quantization unit 2007, into a bit string by performing either variable length coding or arithmetic coding, and outputs the post-conversion bit string to a packetizing unit 300.

The packetizing unit 300 packetizes the bit string that is an output by the entropy coding unit 2012 into packets each including a bit stream segment having a predetermined number of bits. The generated packets are transmitted to the image decoding apparatus via a network.

### (Method)

FIG. 2 is a diagram showing data in slice division scheme performed by the moving picture coding apparatus 1.

The slice division scheme is described with reference to FIG. 2.

A picture (a frame) shown in FIG. 2 is made up of plural blocks. Among the blocks of the picture, the region (I-slice 41) of the block marked with diagonal lines is an I-slice. A region (NoMC-P-slice 42) marked with vertical lines and a white region (a region without hatching, MC-P-slice 44) are refreshed P-slices, and a region (MC-P-slice 43) marked with horizontal lines is a P-slice having an image quality degraded due to transmission error.

The I-slice 41, the NoMC-P slice 42, and the MC-P-slice 44 make up the refreshed region PR4 (FIG. 5). In addition, the MC-P-slice 43 makes up the unrefreshed region PR3 (FIG. 5).

Here, for the slice division determining unit, the following settings are made: the width of a display screen corresponds to Y block lines; the width of the I-slice 41 corresponds to L block lines, the width of the P-slice corresponds to M block lines, and a search range in the vertical direction in motion search is a range including ±w pixels (−w pixel to +w pixel). The slice division determining unit determines the W block lines including w pixels as a NoMC-P-slice line. In short, the slice division determining unit determines the region having a width corresponding to W block lines as a NoMC-P-slice 42 region. For example, when a block line is made up of 16 pixels, W is a positive number equal to or larger than w/16. The other P-slices (the slice (MC-P-slice 44) in the white region) and the slice (MC-P-slice 43) in the region marked with horizontal lines are MC-P-slices. Here, the slice division determining unit may constitute at least a part of the slice type setting unit 103 (setting unit 103a) in FIG. 1.

Here, (a) to (p) in FIG. 2 are pictures that are temporally consecutive in this sequence.

The slice type setting unit 103 performs slice division such that the position of a current I-slice 41 in a current picture is shifted downward by the width of the current I-slice 41 (L lines in this embodiment) with an increment of 1 in the number of pictures notified by the number-of-pictures counting unit 100 to the slice type setting unit 103. The slice type setting unit 103 determines the P-slice corresponding to a region that is located immediately above the I-slice 41 and is marked with vertical lines as a NoMC-P-slice (NoMC-P-slice 42).

The slice type setting unit 103 determines, as the NoMC-P-slice 42, a region (fully) ranging from the top end of the picture to the portion immediately above the I-slice 41, (during a period in which a width corresponding to W block lines cannot be secured for the NoMC-P-slice 42) as shown in (b) and (c) in FIG. 2, that is, by the time when W block lines are secured for the NoMC-P-slice 42 as shown in (d) in FIG. 2. The slice type setting unit 103 divides the remaining region into P-slices at the time of shifting a current I-slice 41, and makes one of the width of the P-slice located at the top end and the width of the P-slice located at the bottom end of the current picture smaller than a width corresponding to M block lines when the width of M block lines cannot be secured for the one of the P-slices located at the both ends. Examples of such slices having a width smaller than the width of M block lines are illustrated as the MC-P-slice 44 located at the top end of (e) and the MC-P-slice 43 located at the bottom end of (d).

In this case, the search range for the block of a slice#slc_n in (n) in FIG. 2 does not include a P-slice in (m) (MC-P-slice 43, unrefreshed region) that has an image quality degraded due to transmission error and marked with horizontal lines. Thus, error propagation, can be prevented. This is because when a decoder decodes a block in the slice#slc_n (a block 44x), the decoder generates an image by decoding the block in the slice#slc_n with reference to only the previously refreshed regions (the refreshed region PR4 in FIG. 5: an I-slice 41 region, a NoMC-P-slice 42 region, and an MC-P-slice 44 region in (m) of FIG. 2).

### (Operation)

FIG. 3 is a diagram showing operations of slice division and slice type determination.

FIG. 4 is a flowchart of processing performed by a moving picture coding apparatus 1.

FIG. 3 illustrates the operations of slice division performed by the slice type setting unit 103 and slice type determination performed by the motion search determining unit 104. FIG. 4 illustrates a flowchart of processing performed by the moving picture coding apparatus 1.

The following example is given assuming that the width L of the I-slice 41 is 1, the width M of the MC-P-slices (MC-P-slice 43, MC-P-slice 44) is 4, and the width W of the NoMC-P-slice 42 is 3.

The slice division determining unit (for example, the slice type setting unit 103) calculates a division size for a slice of a picture, based on the sizes of the I-slice line, MC-P-slice line, and NoMC-P-slice line and the height of the picture, and stores the division size in a memory.

When the number of pictures notified from the number-of-pictures counting unit 100 is incremented by 1, the slice division determining unit updates the division position and size for a next slice. More specifically, the slice division determining unit stores the arrangement and size for each slice as shown in FIG. 3. The number assigned to each of the slices located in a region starting with a start pointer and ending with an end pointer shows the number of macroblock lines in each slice that constitutes the picture. Each slice is associated with a slice type thereof. Each time the number of pictures is incremented by 1, the contents of data to be stored in the slice division determining unit 101 are changed in order from (a) to (j) in FIG. 3. Here, (a) to (j) in FIG. 3 correspond to (a) to (j) in FIG. 2, respectively.

When the picture number is incremented by 1, the slice division determining unit increments, by 1, the value to be stored in the arrangement of positions indicated by the start pointer, and decrements, by 1, the value to be stored in the arrangement of positions indicated by the end pointer. The slice division determining unit shifts, by 1, the position of the start pointer when the width of the slice (indicated by the start pointer) reaches the maximum value (M for an MC-P-slice, and W for a NoMC-P-slice) for the slice (indicated by the start pointer). In short, the slice division determining unit shifts a current slice that is indicated by the start pointer to a slice next to the currently being indicated slice.

The slice division determining unit shifts, by 1, the position of the end pointer when the value is decremented to 0 (in other words, when the height of the slice indicated by the end point is decremented to 0). In short, the slice division determining unit changes a slice that is indicated thereby to a slice located at a next position.

The slice division determining unit determines the width and slice type of a current slice while shifting the positions of the start pointer and the end pointer in this way (S1001). The data shown in FIG. 3 is stored by, for example, the slice division determining unit.

First, the number-of-blocks counting unit 102 sets 0 as the number-of-blocks counter (the value measured by the number-of-blocks counting unit 102) (S1002). The slice type setting unit 103 reads out, from the arrangement in FIG. 3, the slice type and size (the number of macroblock lines) of a current slice to be coded (S1003). Here, the product of the number of macroblock lines and the number of macroblocks in a line (one line) equals to the maximum number of blocks for the slice.

According to the slice type read out from the arrangement, the selector unit 2005 switches prediction image generation schemes (S1004). In other words, the selector unit 2005 changes which prediction image is to be selected as a selected prediction image.

In the case where a current slice to be coded is either an I-slice or a P-slice, the selector 2005 determines, as a candidate prediction image to be selected, an output (a third prediction image) from the intra prediction unit 2004 of the coding unit 200 (S1005).

In the case where a current slice to be coded is a NoMC-P-slice, the selector 2005 determines, as a candidate prediction image to be selected, an output (a first prediction image) from the reference image copying unit 2003 (S1006).

In the case where a current slice to be coded is an MC-P-slice, the selector 2005 determines, as a candidate prediction image to be selected, a second prediction image generated by the motion estimation unit 2001 and the motion compensation unit 2002 of the coding unit 200 (S1007).

It is also good to perform all of the processing of determining the first prediction image, the processing of determining the second prediction image, and the processing of determining the third prediction image irrespective of the slice type read out. Furthermore, it is also possible for the selector unit 2005 to determine, as a candidate prediction image to be selected, only the result of at least one kind of processing corresponding to the type among the results of the three kinds of processing, and exclude the other results from candidates.

Specifically, the selector unit 2005 selects one of the prediction images generated in Steps S1005, S1006, and S1007. More specifically, the selector unit 2005 selects, as a selected prediction image, an image yielding a smaller (the smallest) number of bits when a difference from the current block to be coded is coded, or an image yielding a small number of bits required to code a difference, or and an image yielding a smaller (the smallest) degree of difference. The selector unit 2005 enables the DCT and quantization unit 2007 and the entropy coding unit 2012 (a unit 200a at a later stage) to code the difference (post-subtraction image).

The number-of-blocks counting unit 102 increments the number of blocks by 1 when the coding unit 200 completes the coding in units of a block (S1009). Furthermore, in the case where the number of blocks after the increment of 1 does not reach the maximum number of blocks for the slice, that is, in the case where the setting unit 103a etc. determines that the block to be coded is not the last block in the slice (“No” in S1010), the moving picture coding apparatus 1 codes the next block in Steps S1004 to S1010. In the case where the number of blocks is the maximum number of blocks for the slice (“Yes” in S1010), the moving picture coding apparatus 1 codes the next slice (“Yes” in S1010).

The setting unit 103a, or the like determines whether or not coding of all the slices in the picture is already completed (S1011). In the case where the setting unit 103a, or the like determines that there remains a slice that should be coded, the slice division determining unit (slice type setting unit 103) updates the reading position of the arrangement in FIG. 3 (S1013). Next, the slice type setting unit 103, or the like reads out the arrangement of the next slice (S1003). In the opposite case where the setting unit 103a, or the like determines that coding of all the slices in the picture is already completed (“Yes” in S1011), the number-of-pictures counting unit 100 increments the number of pictures by 1 (S1012). For example, the setting unit 103a, or the like further determines whether or not coding of all the pictures is already completed (S1014). In the case where there remains a picture that should be coded, the moving picture coding apparatus 1 codes the next picture in Steps S1001 to S1011.

It is to be noted that all or some of the P-slices (MC-P-slice and NoMC-P-slice) in the descriptions in this embodiment does not need to always refer to a past image. In other words, each of all or some of the P-slices may be a slice (B-slice) which refers to also a future image in addition to a past image.

According to Embodiment 1, even when some of a stream is lost during transmission via a network and the image quality degrades, it is possible to prevent infinite (long-duration) propagation of the image quality degradation at the time when I-slices corresponding to a picture are received. Furthermore, such error propagation is prevented without dynamically changing the motion search ranges.

FIG. 5 is a diagram showing the relationships between a current picture PS to be coded, a reference picture PR, and a following picture PT that is located subsequent to the current picture PS.

The reference picture PR is a picture coded by the coding unit 200 before the current picture PS is coded. In other words, the reference picture PR is a picture that is referred to in the coding of the current picture PS.

The reference picture PR includes a refreshed region PR4 and unrefreshed region PR3. The refreshed region PR4 includes an I-slice PR2 at the ending point in the forward direction for shifting an I-slice (downward direction). The unrefreshed region PR3 includes a region PR31 in which error propagation may be caused if reference is made to the starting point in the forward direction for shifting an I-slice.

The current picture PS includes a refreshed region PS1 and an unrefreshed region PS3. The I-slice PR2 is included in the refreshed region PS1.

The following picture PT in FIG. 5 is, for example, the picture next to the current picture PS.

In the case where a current block to be coded is not a block in a NoMC-P-slice (a block in the current region PSA2 to be coded), the motion compensation unit 2002 performs coding based on a first prediction image. This makes it possible to select a prediction image to be used sufficiently freely, and concurrently prevent an image in the refreshed region PS1 from being coded with reference to an image in the unrefreshed region PR3. This makes it possible to compress data sufficiently, and concurrently prevent image quality degradation propagation from the unrefreshed region PR3 to the refreshed region PS1.

On the other hand, in the case where a current block to be coded is a block in a NoMC-P-slice (a block in the current region PSA2 to be coded), only the reference image copying unit 2003 performs coding based on the first prediction image, and the motion compensation unit 2002 does not perform coding based on a second prediction image. This makes it possible to prevent image quality degradation propagation from the unrefreshed region PR3 to the refreshed region PS1, and concurrently perform coding according to a simple processing based on the first prediction image.

This reduces the data amount sufficiently. Furthermore, it is possible to achieve both simple processing and prevention of image quality degradation propagation from the unrefreshed region PR3 to the refreshed region PS1.

Here, as described earlier, in the case where a current block to be coded is not a block in a NoMC-P-slice, and when the condition on the number of bits is satisfied in this case, it is also good to perform, as necessary, either coding based on a first prediction image or coding based on a second predictive coding. In the case where a current block to be coded is a block in a NoMC-P-slice, it is good to perform coding based on a second prediction image as necessary. This makes it possible to compress the data more sufficiently.

It is to be noted that a region that is in the I-slice PR2 and is distant from the unrefreshed region PR3 by a predetermined distance (for example, 5 pixels) or shorter is desirably a margin region that is not referred to in the coding based on the first prediction image.

Here, the moving picture coding apparatus 1 performs, for example, deblocking filtering and motion compensation with sub-pixel accuracy.

A region that is in the I-slice PR2 and is distant from the unrefreshed region PR3 by a first distance (for example, 2 pixels) or shorter is a region having a pixel that is affected by the deblocking filtering based on the pixel in the unrefreshed region PR3.

In addition, when the moving picture coding apparatus 1 performs motion compensation with a sub-pixel accuracy (motion compensation using motion vectors estimated for each unit smaller than a pixel) on pixels, a first pixel having a distance from a second pixel by a predetermined second distance (for example, corresponding to 3 pixels) or shorter affects the second pixel.

Accordingly, a region that is in the I-slice PR2 and has a distance from the unrefreshed region RP3 by 5 pixels obtained by adding 3 and 2 (a predetermined distance) is a region including the pixel affected by the pixel in the unrefreshed region PR3.

Such a region that has a predetermined distance (corresponding to 5 pixels) or shorter is desirably a margin region that is not referred to in coding based on the first prediction image. In other words, it is desirable that the width of the NoMC-P-slice 42 (FIG. 2) is large enough to prevent coding based on a first prediction image from being performed on the region (the margin region) having the predetermined distance or shorter.

In this manner, a moving picture coding method is shown below. This moving picture coding method is intended to solve the following problems. In order to prevent, using I-slices, propagation of image quality degradation due to a partial stream loss due to transmission error, it is necessary to dynamically limit motion search ranges such that no unrefreshed region is contained in motion search in a refreshed region. In short, there is a need to perform motion search while modifying the sizes of search ranges according to a current position to be coded. This produces a problem of complex control. The moving picture coding method to solve this problem is intended to stop motion search for the slice (NoMC-P-slice 42) located above the I-slice on which refresh is performed, and thereby preventing error propagation by disabling reference to an unrefreshed region without dynamically limiting the motion search ranges.

Further description is given below. The following description is a mere example.

FIG. 6 is a flowchart of processes performed according to the types of slices (slice types). Specifically, for example, operations shown in FIG. 6 may be performed in processing in FIG. 4.

In the case where MC-P-slice is determined as the type of a current slice by the slice type setting unit 103 (S3001: MC-P), the selector unit 2005 selects, as a selected prediction image, a second prediction image (generated in S3004C) by the motion compensation unit 2002 (S3005C). Even when the MC-P-slice is determined, in an exceptional case, the selector unit 2005 may select either the first prediction image (generated in S3003C) generated by the reference image copying unit 2003 or a third prediction image (generated in S3002C) generated by the intra prediction unit 2004. In this exceptional case, only the third prediction image may be selected.

In the case where NoMC-P-slice is determined as the type of a current slice by the slice type setting unit 103 (S3001: NoMC-P), the selector unit 2005 selects a first prediction image (generated in S3003B) (S3005B). Even when the NoMC-P-slice is determined, in an exceptional case, the selector unit 2005 may select a third prediction image (generated in S3002B).

In the case where I-slice is determined as the type of a current slice by the slice type setting unit 103 (S3001: I), the selector unit 2005 selects a third prediction image (generated in S3002A) (S3005A).

For example, it is also possible to perform, in parallel, the following three series of processes: a series of processes performed by the intra prediction unit 2004, a series of processing performed by the reference image copying unit 2003, and a series of processes performed by the motion estimation unit 2001 and the motion compensation unit 2002.

Here, in the case where a slice type is determined (S3001), all of these three series of processes may be performed irrespective of the determined slice type. For example, in the case where an MC-P-slice is determined (S3001: MC-P), all of these three series of processes (S3002C (S1005), S3003C (S1006), and S3004C (S1007) may be performed. On the other hand, in the case where a NoMC-P-slice is determined (S3001: NoMC-P), it is also good to perform only two series of processes that are the series of processes by the intra prediction unit 2004 and the series of processes by the reference image copying unit 2003 (S3002B (S1005), S3003B (S1006)), and not to perform the series of processes by the motion compensation unit 2002 (S1007). Likewise, in the case where an I-slice is determined (S3001: I), it is also good to perform only the series of processes by the intra prediction unit 2004 (S3002A (S1005)), and not to perform the other two series of processes (S1006, S1007).

More detailed descriptions are given below. The following description is also a mere example.

The moving picture coding apparatus (moving picture coding apparatus 1) includes slice type setting units (a slice type setting unit 103, and a setting unit 103a), a selector unit (selector unit 2005), and a difference processing unit (a unit 200a at a later stage). The unit 200a at a later stage includes a subtractor 2006, a DCT and quantization unit 2007, an entropy coding unit 2012, etc. For example, each of the slice type setting units 103, etc. may be a functional block implemented as a circuit.

The slice type setting unit determines the positions of I-slices (I-slice PR2, I-slice PS2, and I-slice PT1) in pictures (a reference picture PR, a current picture PS, and a following picture PT, etc.). The slice type setting unit determines, for such I-slices, mutually different positions in plural pictures.

The difference processing unit codes a moving picture by coding a difference between each of the blocks in each picture of a moving is picture and a prediction image selected for a corresponding one of the blocks.

The selector unit selects a prediction image, and thereby allowing the difference processing unit to use the selected prediction image.

More specifically, when selecting a prediction image as a selected prediction image, the selector unit selects a previous image that is a reference picture (reference picture PR) coded before a current picture to be coded (a current picture PS) is coded. This selection is described in more detail below.

The selector unit makes such a selection according to a particular region (a NoMC-P-slice 42 region (a first region R1)), which is described in detail later, in the current picture to be coded.

Here, the particular region is a region (a NoMC-P-slice 42 region) which is in the refreshed region PS1 and for which an unrefreshed region PR3 in the reference picture (reference picture PR) may be referred to.

Here, the refreshed region PS1 is a region including the portions corresponding to I-slices 41 (I-slices PR2) in the respective pictures preceding the picture (the current picture PS). The unrefreshed region PR3 is a region including the portions corresponding to I-slices 41 (I-slice PT1) in the respective pictures succeeding the picture (the reference picture PR).

For each of blocks in slices in the region other than the particular region, the selector unit selects, as a selected prediction image, a block (a second prediction image) that is located at a position other than the position for the block in the reference picture. On the other hand, as for the particular block (a block in the NoMC-P-slice 42), the selector unit does not select the block (the second prediction image) among the blocks in the reference picture. For the particular block, the selector unit selects, as a prediction image, a block (a first prediction image) co-located with the particular block.

In this way, one-cycle I-slice insertion makes it possible to enhance picture quality and concurrently prevent the amount of data of some pictures from increasing to an excess. Since a first prediction image is used for the particular region, it is possible to prevent image quality degradation propagation from the unrefreshed region PR3 to the refreshed region PS1. In this way, a simple use of the co-located second prediction image prevents image quality degradation propagation. This makes it possible to achieve both prevention of such propagation and simple processing. This allows high-speed processing, and thereby making it possible to achieve both prevention of such propagation and processing of high-resolution data such as high-definition data.

As an exception, an image (such as a first prediction image) other than a second prediction image may be selected for a block in the other region. Likewise, as an exception, an image other than a first prediction image may be selected for a block in the particular region. For example, the slice type setting unit holds data (FIG. 3) specifying the type of each slice included in a picture. For example, the slice type setting unit modifies the contents of the held data into contents specifying, as the NoMC-P-slice 42, the type of a slice in the particular region. For example, the selector unit may perform the above processing based on the contents of such held data. Here, the contents of the held data may include, for example, information specifying the position, range and type of each slice in a picture and information specifying the top and end of the picture.

More specifically, for example, the moving picture coding apparatus 1 may be provided in a television conference system for transmitting a moving picture for a television conference between a first lodgment and a second lodgment. The moving picture coding apparatus 1 may code the moving picture to be transmitted for the television conference. Such a moving picture may be, for example, a full high-definition moving picture for use in a television conference.

It is also possible to prevent delay in transmission by reducing the degree of variation in data amount per unit of transmission of the data to be transmitted as described above so as to prevent delay and stoppage in display of the moving picture to be transmitted. In this way, it is possible to enhance a sense of reality in the television conference using the moving picture to be displayed.

In this way, for example, it is also good to perform processing according to a first region R1 (FIG. 5) and a second region R2. The following processing is a mere example. The following processing may be performed only in a certain case indicated below.

In the case of plural pictures (for example, pictures (a) to (p) in FIG. 2), the setting unit 103a may set an I-slice 41 for a picture (for example, (d)) at a position next to the position of the I-slice 41 set for the immediately-preceding picture (for example, (c)).

Here, compared with the position of the I-slice for the immediately-preceding picture, the next position is located downward in the forward direction (the downward side in FIG. 2) for a current I-slice 41 and is co-located with the I-slice 41 of the immediately-preceding picture.

The setting unit 103a may shift, for each picture, the position of the I-slice 41 in the forward direction.

Next, a second inter coding unit 192 may code blocks (in the MC-P-slices 43 and 44) in the current picture PS to be coded (FIG. 5), utilizing a prediction image (a second prediction image) within a search range (search range SA) for each of the blocks in the reference picture PR.

More specifically, in the coding, it is also possible to code each of the blocks by generating a difference between the block to be coded and a prediction image, and coding the generated difference.

More specifically, such a prediction image may be, for example, a second prediction image located in a search range of the reference picture PR.

The second inter coding unit 192 may perform a part or all of the functions of the unit 200a at a later stage.

Here, the search range (see a search range S×2 in FIG. 25) for a block in a second region R2 (FIG. 5) does not always need to contain an overlap area with the unrefreshed region PR3. On the other hand, the search range (see a search range S×1 in FIG. 25) for a block in a first region R1 may contain an overlap area with the unrefreshed region PR3.

In this case, there is no propagation of such degradation even when the second prediction image is used in the coding of the blocks in the second region R2. In the opposite case where the second prediction image is used in the coding of the blocks in the first region R1, such degradation is inevitably propagated.

Here, the first prediction image (generated by the reference image copying unit 2003) for each of blocks (blocks B1 and B2) in the first region R1 is an image co-located with the current block in the reference picture PR.

The position of the first region R1 is within the refreshed region PS1 in the current picture PS. Therefore, the position co-located with the position of the first region R1 in the reference picture PR is within the refreshed region PR4.

Accordingly, the position of the first prediction image for each block located in the region R1 is within the refreshed region PS1 in the current picture PS.

For this reason, it is also possible (for the second inter coding unit 192) to use the second prediction image in the coding of each block in the second region R2, and it is also possible (for the first inter coding unit 191) to use the first prediction image in the coding of each block in the first region R1.

In other words, it is also possible for the second inter coding unit 192 to perform coding using the second prediction image only on the blocks in the second region R2, and not to perform such coding on the blocks in the first region R1. Likewise, it is also possible for the first inter coding unit 191 to perform coding using the first prediction image on the blocks in the first region R1, but not to perform such coding on the blocks in the second region R2.

In this way, the prediction image (first prediction image) in the refreshed region PR4 in the reference picture PR is used in the coding of the blocks in the first region R1, and thereby making it possible to prevent propagation of such degradation.

In addition to this, since the first prediction image is also used to code each of the blocks (blocks B1 and B2: FIG. 5) in the first region R1, the processes performed are not different from each other so much.

For this reason, no complex circuits are required as circuits (hardware) that codes these blocks. Thus, it is possible to simplify the configuration of an implementation by simply configuring the circuits to be used, and to increase the processing speeds.

It is to be noted that, in the (earlier-described) conventional example, two blocks (blocks B1 and B2: see FIG. 26) are coded using mutually different two search ranges by dynamically changing the search ranges. For this reason, the conventional example necessitates complex circuits, resulting in complex configuration and slow processing speeds.

As described earlier, the setting unit 103a may set a NoMC-P-slice 42 in the first region R1. It is also good that a P-slice (MC-P-slice 43x) other than the set NoMC-P-slice 42 is coded based on a second prediction image, and that the set NoMC-P-slice 42 is coded based on a first prediction image.

### Embodiment 2

### (Structure)

FIG. 7 is a block diagram showing a structure of a moving picture coding apparatus 1A in Embodiment 2 according to the present invention. The same descriptions about the same structural elements as those of the moving picture coding apparatus 1 in Embodiment 1 are not repeated in the following descriptions,

In the case where a transmission error occurs, a number-of-cycles-of-slice-insertion setting unit 105 (for example, an element of a selecting unit 105x (FIG. 28)) determines the number of cycles of I-slice insertion performed by the moving picture coding apparatus 1A so that the moving picture coding apparatus 1A performs picture refresh for prevention of propagation of image quality degradation. Next, the number-of-cycles-of-slice-insertion setting unit 105 notifies each of a slice type setting unit 103 and a motion search determining unit 104 of the determined number of cycles of slice insertion. The number-of-cycles-of-slice-insertion setting unit 105 makes such a determination of the number of cycles of slice insertion, based on a scheme of transmitting a result of coding (S2001 in FIG. 10), a bit rate in a network for the transmission (S2002), whether or not occurrence of a transmission error at a receiver side is notified (S2003), etc. More specifically, in this determination process, the number-of-cycles-of-slice-insertion setting unit 105 selects either inserting an I-slice repeatedly or I-slices in an infinite number of cycles (S2005A in FIG. 10), or inserting I-slices only in a predetermined number of cycles (S2005B). When selecting the latter, the number-of-cycles-of-slice-insertion setting unit 105 specifies the selected number of cycles of slice insertion. In this process, in a certain case (S2004: No), the number-of-cycles-of-slice-insertion setting unit 105 may specify 0 cycles as the number of cycles of slice insertion and select not inserting I-slices, as will be described in detail later.

FIG. 8 is a diagram showing an example of a difference in the number of cycles of I-slice insertion. FIG. 8(a) shows a case of I-slice insertion performed in an infinite number of cycles, and FIG. 8(b) shows a case of I-slice insertion performed in only once.

FIG. 9 is a flowchart showing how the moving picture coding apparatus 1A performs such processes according to the number of cycles of slice insertion.

The motion search determining unit 104 performs the processing indicated below in one of the following cases (S41 in FIG. 8: YES, S41a): a case where the infinite-number-of-cycles-of-insertion is determined to be the insertion scheme, based on the insertion scheme and the number of cycles of insertion notified by the number-of-cycles-of-slice-insertion setting unit 105; and a case where the predetermined-number-of-cycles-of-insertion more than a threshold value is specified as the I-slice insertion scheme. In short, the processing performed here is processing of determining the slice located immediately above a current I-slice to be an MC-P-slice to (S4000 in FIG. 9: YES, S4001). Subsequently, in the case where the slice insertion scheme is predetermined-number-of-cycles-of-insertion and the number of cycles of insertion is not larger than a predetermined number of cycles (that is the aforementioned threshold value) (S41: NO, S41b), the motion search determining unit 104 determines the slice located immediately above a current I-slice to be an NoMC-P-slice (S4000 in FIG. 9: No, S4002). In the case where the cycle scheme notified by the number-of-cycles-of-slice-insertion setting unit 105 is the finite-number-of-cycles-of-insertion (S2005C in FIG. 10), the motion search determining unit 104 decrements the number of held cycles by 1 each time the slice located at the bottom of a picture is determined to be a current I-slice. When decrementing the number of cycles held to 0, the motion search determining unit 104 determines each of all the slices to be an MC-P-slice.

It is to be noted that, for example, a fixed value depending on the size (the number of vertical lines) of a picture may be set as the predetermined value (the predetermined number of cycles) used to determine the number of cycles of I-slice insertion.

### (Operation)

The number of bits of coded data increases when inter coding without motion search is performed, compared to the case where inter coding with motion search is performed. This is because motion search is performed such that a difference value between a current image to be coded and a prediction image becomes small. Stated differently, inter coding without motion search requires coding a difference value larger than a difference value in inter coding with motion search.

On the other hand, inter coding with motion search does not guarantee that image quality degradation due to a packet loss in a network is stopped by refresh by I-slice insertion. However, in the case of frequently performing refresh by I-slice insertion (S41 in FIG. 8: YES, S4000 in FIG. 9: YES), it is highly likely that prediction based on only a refreshed region (the refreshed region PR4 in FIG. 5) is made at least once even in the case of coding an MC-P-slice. One-time prediction based on such a refreshed region is sufficient to stop error propagation. Thus, in the case where refresh by I-slice insertion is frequently performed (S41 in FIG. 8: YES, S4000 in FIG. 9: YES), it is desirable that the number of bits required to code data is reduced using only an MC-P-slice without using a NoMC-P-slice (S4001 in FIG. 9).

For this reason, in the case where the number of cycles of refresh by I-slice insertion is equal to or larger than a predetermined value (including an infinite number of cycles) (S4000 in FIG. 9: YES), the moving picture coding apparatus 1A in Embodiment 2 determines each of all the P-slices to be an MC-P-slice (S4001). Meanwhile, in the case where the number of cycles of refresh by inserting I-slices is not larger than the predetermined value (S4000: No), the moving picture coding apparatus 1A uses both a NoMC-P-slice and an MC-P-slice as in Embodiment 1 (S4002).

In this way, in the case where I-frames are inserted in an infinite number of cycles (cyclically) (S4000: YES), the moving picture coding apparatus performs the process of S4001. This process of S4001 is also performed in the case where I-slices are inserted in a predetermined large number of cycles (cyclical effect is large) when, for example, a packet loss occurs. On the other hand, the process of S4002 is performed in the case where I-slices are inserted in a predetermined number of cycles (I-slices are inserted simply non-cyclically, and the cyclical effect is small) (S4000: NO). Thus, supposing that image quality degradation propagates from an unrefreshed region PR3 to a refreshed region PS1, when a large number of I-slices is inserted in the pictures succeeding a current picture (S4000: YES), the influence of such propagation only continues for a short time. In this case, the second prediction image is used without use of a NoMC-P-slice, and thus the resulting data is compressed to a smaller size. In the opposite case where the number of I-slices to be inserted is small (S400: NO), the influence of such propagation continues for long time. Thus, a NoMC-P-slice is used to stop such propagation. In this way, it is possible to achieve both suppression of image quality degradation due to such propagation and a small data amount. To be summarized, processing to be performed is changed depending on whether or not I-slices are inserted. Specifically, I-slices are inserted in the case where the number of I-slices is large, but no I-slice is inserted in the case where the number of I-slices is small.

In this way, processing may be performed depending on (i) the bandwidth of a network through which data of coded pictures is transmitted, (ii) whether or not a receiver side that receives transmitted data notifies a coding apparatus that performs coding of occurrence of a decoding error at the receiver side, and (iii) a transmission scheme of distributing the data to other receivers at the same time. It is also good to select, depending on these, either a first insertion scheme of inserting I-slices repeatedly in cycles or a second insertion scheme of inserting I-slices only in a predetermined number of cycles, as the I-slice insertion scheme. Furthermore, it is also good that the moving picture coding method may include a setting process of setting the insertion scheme selected in this way, and that the third coding process involves inter coding in the case where the set insertion scheme is the first insertion scheme. Furthermore, it is also good that the fourth coding process involves inter coding in the case where the set insertion scheme is the second insertion scheme.

For example, more specifically, it is also good that the third coding process is performed when the set insertion scheme is for a certain case (where the number of cycles of insertion is larger than a predetermined number) among cases using the second insertion scheme. In addition, it is also good that the fourth coding process is performed when the set insertion scheme is not the predetermined case (the other case where the number of cycles of insertion is not larger than the predetermined number) among cases using the second insertion scheme.

FIG. 10 is a flowchart of a number-of-cycles-of-slice-insertion setting unit 105.

Descriptions thereof are given below with reference to FIG. 3 that is a diagram illustrating operations performed by the slice type setting unit 103, FIG. 4 that is a flowchart of processing performed by the moving picture coding apparatus (moving picture coding apparatus 1A), and FIG. 10 that is a flowchart of processing performed by the number-of-cycles-of-slice-insertion setting unit 105.

As shown in FIG. 10, the number-of-cycles-of-slice-insertion setting unit 105 determines that I-slices are inserted in an infinite number of cycles (S2005A, S4000 in FIG. 9: YES, S41 in FIG. 8: YES) in the cases indicated below. The number-of-cycles-of-slice-insertion setting unit 105 notifies the slice type setting unit 103 and the motion search determining unit 104 of the determination. (1) One of such cases is a case where packets are multicast to a large number of (more than a predetermined number of) image decoding apparatuses (distribution in S2001), and it is difficult for each of the image decoding apparatuses to perform a refresh operation after receiving packet loss information (“YES” in S2001). (2) Another case is a case where the bit rate in a network for transmission is low, and thus frequently inserting I-slices having a low compression rate (having a high bit rate) (and performing error control in addition to such frequent insertion) would require a large data amount for the data that is transmitted via the network, resulting in significant image quality degradation (“NO” in S2002). (3) Still another case is a case where the moving image coding apparatus 1A is connected with an image decoding apparatus incapable of notifying the moving image coding apparatus 1A of occurrence of a packet loss in a communication path (“NO” in S2003).

In the case where the moving image coding apparatus 1A is connected with an image decoding apparatus capable of notifying a packet loss, and a packet loss occurs in a transmission network (“YES” in S2004), the number-of-cycles-of-slice-insertion setting unit 105 determines that I-slices are inserted in a finite number of cycles (that is assumed to be 1 in the descriptions in this embodiment) (S2005C). The number-of-cycles-of-slice-insertion setting unit 105 notifies the motion search determining unit 104 of the determination. In the case where no packet loss occurs in the network, the number-of-cycles-of-slice-insertion setting unit 105 does not notify the motion search determining unit 104 of I-slice insertion (“NO” in S2004). It is to be noted that, when the network is NGN (Next Generation Network), the network provider guarantees that no packet loss occurs. The number-of-cycles-of-slice-insertion setting unit 105 may perform processing of S2005B when the network is NGN.

As describe above, according to Embodiment 2, the moving picture coding apparatus 1A determines the number of cycles of inserting I-slices. More specifically, the moving picture coding apparatus 1A makes such a determination according to the number of destination image decoding apparatuses (S2001), the bit rate (S2002), whether an image decoding apparatus that is connected thereto is capable of making a notification of presence/absence of a stream packet loss in the network (S2003), and the presence/absence of the stream packet loss (S2004). In this way, how to insert I-slices is updated, and an image coding apparatus 1A which performs coding with consideration of a decrease in compression rate.

### Embodiment 3

An moving image coding method according to Embodiment 3 includes a first coding process of performing inter coding without using any motion vectors on each of first P-slices (NoMC-P-slices 42Aa and 42Ab) included in a first region (the first region R1 in FIG. 19). In this first coding process, the maximum value for the size of each of the first P-slices (NoMC-P-slices 42Aa and 42Ab) is smaller than the maximum value for the size (the size of the MC-P-slice 43 in FIG. 19) of second P-slices (MC-P-slices 43 and 44 in FIG. 19).

Here, the maximum value for the size (for example, the size of the NoMC-P-slice 42Aa) of the first P-slice (NoMC-P-slice 42A) may be larger than the size of the I-slice (I-slice 41 in FIG. 19) in the picture (picture PS in FIG. 19) including the first P-slices (NoMC-P-slices 42Aa and 42Ab) having the size corresponding to the maximum value.

Each of FIG. 11 to FIG. 13 is a diagram for illustrating Embodiment 3.

The moving image coding apparatus in this embodiment may have the same structure as in FIG. 1, for example. Furthermore, for example, the moving image coding apparatus may perform the same processing as in the processing indicated by the flowchart in FIG. 4 or the same processing as in FIG. 6.

As described earlier, the moving image coding apparatus may code a difference value between an input image signal and an image signal of the pixel located at a position which has the highest correlation with the input image signal. Coding without motion search produces a large difference value, compared to coding with motion search. Since the difference value is large, the number of bits required for coding is large. This means an increase in the number of bits required to code the slices in a range (NoMC-P-slice) without motion search.

A slice having a large number of bits is likely to be lost. Maintaining the number of bits for coding slices at a certain value (reducing the variation range (variation) in the number of bits) makes it possible to reduce the number of times of a loss by transmission via a network. Furthermore, in the case of network transmission at a certain bit rate according to the capacity of the network, and when the number of bits for coding slices is maintained in this case, it is only necessary that a stream including the slices is transmitted at a certain time interval, and thus network control is simple.

For this reason, the size (the number of blocks) of a slice (NoMC-P-slice) in the case of coding without motion search, that is, the size of a slice that requires a large number of bits when coded is made smaller than the size (the number of blocks) of a slice (MC-P-slice) in the case of coding with motion search. It is good to maintain the number of bits for coding slices in this way. In the case where a range (first region R1) for which no motion search should be performed is larger than the slice (NoMC-P-slice) in the case of coding without motion search, a plural number of slices for which no motion search is performed is determined to obtain a range not for motion search (the first region R1) having a necessary size.

For example, the next operations may be performed.

FIG. 13 shows a current region PSA2 to be coded.

FIG. 11 shows plural NoMC-P-slices 42A.

The current region PSA2 to be coded includes (at least two portions of) a first current region PSAa to be coded and a second current region PSA2b to be coded.

The first current region PSAa is a region in which the first NoMC-P-slice 42Aa (FIG. 11, FIG. 19) are set.

The second current region PSAb is a region in which the second NoMC-P-slice 42Ab (FIG. 11, FIG. 19) are set.

Here, the NoMC-P-slice (NoMC-P-slices 42, 42A) are coded without using a second prediction image. For this reason, the amount of data of the coded NoMC-P-slice 42 is comparatively large. Examples of such a large data amount includes a data amount 10 times the data amount of a slice (for example, an MC-P-slice) that is other than the NoMC-P-slice 42 and is coded using a second prediction image.

Here, in many cases, a slice is a unit of one-time transmission.

For this reason, the data amount of the NoMC-P-slice 42 per unit of transmission may increase to 10 times for example, and thus the variation range in data amount per unit of transmission may become large.

In the case where the variation range in data amount per unit of transmission is large in this way, for example, it is likely that data loss occurs in the transmission network.

As shown in FIG. 11, each of the plural NoMC-P-slices 42A having a comparatively small size may be set by the slice type setting unit 103 in the first region R1 (S1001).

Such a comparatively small size is, for example, approximately ½ the size of the NoMC-P-slice in FIG. 2 in Embodiment 1.

This suppresses a large increase in the range of variation in the data amount per unit of transmission, and thereby allowing more appropriate transmission.

More specifically, for example, it is also good to use the data structure in FIG. 12. For example, it is also good to store the height of the first NoMC-P-slice 42Aa (the first-line data in each of (a) to (j)) and the height of the second NoMC-P-slice 42Ab (the second-line data).

Furthermore, it is also good to determine that the kinds of the respective two NoMC-P-slices 42A that are the first NoMC-P-slice 42Aa and the second NoMC-P-slice 42Ab are NoMC-P (S3001: NoMC-P, S1004: NoMC-P).

Furthermore, in this case, it is also good to perform S3002B to S3005B (S1006) on each of the NoMC-P-slices 42A.

### Embodiment 4

A moving picture coding method in Embodiment 4 is intended to code each of a first picture (the picture (i) in FIG. 17) that includes an I-slice and P-slices and is at a first time point (for example, at the time point of (i) in FIG. 17) and a second picture (the picture (k) in FIG. 17) that includes an I-slice and P-slices and is at a time point (for example, at the time point for (k) in FIG. 17) that is later than the first time point, and further code a third picture (the picture (j) in FIG. 17) that does not include any I-slice and is at a time point (the time point for (j)) between the first time point and the second time point.

Here, for example, in the moving picture coding method, the third picture ((j) in FIG. 17) may include a region R3 including both a first region (a NoMC-P-slice 42 region in (i) in FIG. 17, a first region R1) and an I-slice region (I-slice PR2 in (i) in FIG. 17) in the first picture ((j) in FIG. 17). In addition, the first coding process (performed by a first inter coding unit 191, Sa1) may be inter coding performed without using motion vectors on a first P-slice (NoMC-P-slice) 42M in the region R3 in the third picture ((j) in FIG. 17), and the second coding process (performed by a second inter coding unit 192, Sa2) may be inter coding performed using motion vectors on a second P-slice PMx in a region that is other than the region R3 within the third picture (picture (j)).

Likewise, in the moving picture coding method, the third picture ((j) in FIG. 18) may include the region (a region R3 in FIG. 18) corresponding to the first region (the I-slice 41 region) in a second picture ((k) in FIG. 18). In addition, the first coding process may be inter coding performed without using motion vectors on a first P-slice (NoMC-P-slice) 42N in the corresponding region R3 in the third picture ((j) in FIG. 18), and the second coding process may be inter coding is performed using motion vectors on a second P-slice PNx in a region that is other than the corresponding region R3 within the third picture ((j) in FIG. 18).

In addition, in the moving picture coding method, the first coding process may be inter coding performed without using motion vectors on each of the first P-slices (NoMC-P-slices) 42B in the region R3 in the third picture ((j) in FIG. 20). Also, the maximum value for the size of each of the first P-slice 42B in the third picture ((j) in FIG. 20) may be smaller than the maximum value for the size of the second P-slice PMx in the third picture ((j) in FIG. 20).

In addition, in the moving picture coding method, the first coding process may be inter coding performed without using motion vectors on each of the first P-slices (NoMC-P-slices) 42C in the third picture ((j) in FIG. 21). Also, the maximum value for the size of each of the first P-slice 42C in the third picture ((j) in FIG. 21) may be smaller than the maximum value for the size of the second P-slice PNx in the third picture ((j) in FIG. 21).

This is described in detail below.

FIG. 17 is a diagram showing NoMC-P-slices 42M and the like.

More specifically, for example, there is a picture PM for which no I-slice is set as shown in FIG. 17.

The picture PM is, for example, a picture at an intermediate time point. The intermediate time point is between an early time point in the picture PR ((i) in FIG. 17) for which an I-slice PR2 is set and a later time point the picture PS ((k) in FIG. 17) for which an I-slice PR2 is set. More specifically, the picture PM at the intermediate time point is, for example, a picture that is immediately succeeding the picture PR or a picture that is immediately preceding the picture PS. In short, the picture PR may be the picture preceding the picture PM, and may be the picture next to the picture PM.

The picture PR at the earlier time point may be, for example, a past picture at the latest time point among the pictures for which an I-slice is set, in the case where the picture PM at the intermediate time point is processed.

As the intermediate picture PM, a NoMC-P-slice 42M may be set by the setting unit 103a (Step Sa0b).

The NoMC-P-slice 42M to be set is, for example, a slice of the region R3 including both the NoMC-P-slice 42 region and the I-slice PR2 region in the picture PR at the earlier time point as shown in FIG. 17.

In this way, it is also good to stop propagation of image quality degradation from unrefreshed regions (an I-slice PR2 region, a NoMC-P-slice 42 region, and an MC-P-slice 44 region) of the picture PR at the earlier time point to refreshed regions (a NoMC-P-slice 42M and an MMC-P-slice 44) of the picture PM at the intermediate time point.

Stopping such degradation in the refreshed region of the picture PM at the intermediate time point in this way securely prevents such degradation propagation from the refreshed region in the picture PM at the intermediate time point to the refreshed region of the picture PS at the later time point (see FIG. 5, etc.). In this way, it is possible to securely stop the degradation propagation to the refreshed region of the picture PS at the later time point.

More specifically, as shown in FIG. 17, for example, at least one of MC-P-slices PRx (MC-P-slices 44, 43) may be set in the picture PR at the earlier time point by the setting unit 103a, in addition to a NoMC-P-slice 42 and an I-slice PR2.

In addition, as shown in FIG. 17, an MC-P-slice PRx having the same width as that of the MC-P-slice PRx may be set to be co-located with the MC-P-slice PRx. In short, an MC-P-slice PMx region co-located with the MC-P-slice PRx region may be set in the picture PM at the intermediate time point.

In other words, the setting unit 103a may perform slice division in the regions that are other than the NoMC-P-slice 42M region within the picture PM at the intermediate time point, as in the same manner as the slice division performed on the picture PR at the earlier time point.

In this way, the slice division in the picture PM at the intermediate time point may be division corresponding (similar) to the slice division in the picture PR at the earlier time point.

This makes it easier to perform slice division.

Such a picture PM at the intermediate time point (FIG. 17) may be plural pictures PM. More specifically, for each of at least two time points between the earlier time point for the picture PR and the later time point for the picture PR, pictures PM at intermediate time points may be set. In addition, the processing described above may be performed on each of the intermediate pictures PM.

In this way, the region R3 for which a NoMC-P-slice 42M is set in the picture PM at the intermediate time point may include a I-slice region and a NoMC-P-slice 42 region in the picture PR which includes an I-slice (I-slice PS2) and immediately precedes the picture PM at the intermediate time point.

FIG. 18 is a diagram showing NoMC-P-slices 42N and the like.

On the other hand, as shown in FIG. 18, a NoMC-P-slice 42N may be set in the picture PN at the intermediate time point.

The NoMC-P-slice 42N to be set is a slice region co-located with the NoMC-P-slice 42 region in the picture PS at the later time point.

An MC-P-slice PNy may be set in the picture PN at the intermediate time point such that the MC-P-slice PNy region is co-located with the I-slice 41 region in the picture PS at the later time point.

In this way, for example, a normal MC-P-slice (MC-P-slice PNy) may be set in the co-located region.

In addition, an MC-P-slice PNx may be set in the picture PN at the intermediate time point such that the MC-P-slice PNx region is co-located with the MC-P-slice PSx region in the picture PS at the later time point.

In short, in this way, slice division in the picture PN at the intermediate time point may be the same as in the picture PS at the later time point, in the regions that is other than an MC-P-slice PNy region (an I-slice 41 region in the picture PS at the later time point).

In this way, slice division in MC-P-slices PNy regions may be different only in the kinds of slices (MC-P-slice, I-slice).

Slice division in the picture PN at the intermediate time point may be division corresponding (similar) to the division in the picture PS at the later time point.

This makes it easier to perform slice division.

In addition, the NoMC-P-slice 42N in FIG. 18 is smaller than the NoMC-P-slice 42M in FIG. 17. More specifically, for example, the NoMC-P-slice 42N in FIG. 18 may be smaller than the NoMC-P-slice 42M in FIG. 17 by the width of a shift of a current I-slice from the position of the I-slice 41 in the picture PR at the earlier time point to the position of the I-slice PS2 in the picture PS at the later time point.

In addition, no first prediction image is used to code the blocks in the NoMC-P-slice 42N, and thus the amount of coded data is comparatively large.

Thus, reducing the size of the NoMC-P-slice 42N to a comparatively small size is reducing the size of a slice that requires a large data amount when coded. This makes it possible to increase coding efficiency.

FIG. 20 is a diagram showing a picture PMB at an intermediate time point, etc.

In the picture PMB at the intermediate time point, division corresponding to the division in the picture PR at the earlier time point is performed as in the earlier-described case of FIG. 17.

As in the example of FIG. 11 and the like, plural NoMC-P-slices 42B are set.

In this way, it is possible to reduce the size of each of the NoMC-P-slices 42B to be set. Not only this, it is possible to achieve more appropriate transmission as in the case of FIG. 11.

The number of NoMC-P-slices 42B included in the plural NoMC-P-slices 42B may be two, three, or any.

FIG. 21 is a diagram showing a picture PMC at an intermediate time point, etc.

In the picture PMC at the intermediate time point, division corresponding to the division in the picture PS at the later time point is performed as in the earlier-described case of FIG. 18.

As in the example of FIG. 11 and the like, plural NoMC-P-slices 42C are set.

In this way, transmission can be performed more appropriately.

The number of NoMC-P-slices 42B included in the plural NoMC-P-slices 42B may be two, three, or any.

As illustrated in FIG. 19, the following is possible.

Since no motion compensation is performed in coding of a NoMC-P-slice, there is a possibility that the number of bits of coded data exceeds the number of bits of coded data of a slice having the same number of blocks as the number of blocks of the NoMC-P-slice to be coded.

For this reason, the number of blocks in the NoMC-P-slice (NoMC-P-slice 42A) may be smaller than the number of blocks in a normal P-slice (MC-P-slice 43). This prevents an excess increase in the number of bits of a coded NoMC-P-slice, resulting in a small number of bits. Not only this, it is also possible to reduce the possibility of packet losses on a transmission path through which the coded data is transmitted.

Here, for example, an I-slice may be a unit of transmission (a packet) on well-known transmission standards. When the size of a unit of transmission exceeds a certain size, packet losses tend to occur.

Since reducing the number of blocks of a NoMC-P-slice 42A prevents (reduces), for example, the possibility that the size of a unit of transmission exceeds a certain size as described in the above example, it is also good to prevent the possibility by doing so, and thereby reducing the possibility of packet losses.

### Embodiment 5

In Embodiment 5, a program for implementing the moving picture coding apparatuses (the moving picture coding apparatuses 1 and 1A) shown in Embodiments 1 to 4 is recorded on a recording medium such as a flexible disc. With this, the processing shown in Embodiments 1 to 4 is performed in an independent computer system. The following is an example of such processing.

Each of FIG. 14 to FIG. 16 is an illustration of a case of implementing, in a computer system, each of the moving picture coding apparatuses in the above embodiments, using the aforementioned program recorded on a recording medium such as a flexible disc.

FIG. 14 is a diagram showing an example of a physical format of a disc FD that is a flexible disc (see FIG. 15).

FIG. 15 shows a front view (the left portion) of the flexible disc, a cross-sectional view (the middle portion) of the flexible disc, and a disc FD (the right portion).

The flexible disc includes a case F, and the disc FD included in the case F. A plurality of tracks Tr are formed concentrically on the surface of the disc FD from the periphery into the inner radius of the disc FD. Each track Tr is divided into 16 sectors Se in the angular direction. Accordingly, the program is recorded in an area allocated for it on the flexible disc (FD).

FIG. 16 is a diagram showing the structure of a computer system Cs which records the program on the flexible disc, reads the program from the flexible disc, and executes the program. For example, in the case of recording the program for implementing one of the moving picture coding apparatuses on such a flexible disc, the computer system Cs writes the program on (the disc FD of) the flexible disc through a flexible disc drive FDD.

Alternatively, the computer system Cs may execute the program recorded on the flexible disc. In addition, when the moving picture coding apparatus is configured in the computer system Cs using the program, the program is read out from the flexible disc through the flexible disc drive FDD and is transferred to the computer system Cs through the flexible disc drive FDD. The computer system Cs executes the transferred program to cause the moving picture coding apparatus to exert its functions.

It is to be noted that the above description is given assuming that the recording medium is a disc (flexible disc) FD, but an optical disc can be used instead. In addition, the recording medium is not limited thereto, and recording media such as IC cards, ROM cassettes, USBs (Universal serial buses), memory cards, and the like can also be used for the implementation. In addition, the recording medium is not limited to recording media attachable to/detachable from the computer system Cs. The computer system Cs may execute a program recorded on an HDD (Hard Disc Drive) of the computer system Cs, a non-volatile memory, a RAM, a ROM, an SDD (Solid State Drive), or the like. Alternatively, the computer system Cs may execute a program obtained from outside the computer system Cs via a wired or wireless communication network.

Each of the other moving picture coding apparatuses shown in Embodiments 1 to 4 is also implemented in the computer system Cs.

Each of the functional blocks of each moving picture coding apparatus may be implemented as an LSI that is an integrated circuit. These functional blocks may be made as separate individual chips, or as a single chip to include a part or all thereof. For example, the functional blocks other than the memory may be integrated into a single chip. LSI is mentioned here, but there are instances where, due to a difference in the degree of integration, the designations IC, system LSI, super LSI, and ultra LSI are used.

The means for circuit integration is not limited to an LSI, and implementation with a dedicated circuit or a general-purpose processor is also available. It is also acceptable to use an FPGA (Field Programmable Gate Array) that is programmable after the LSI is manufactured, and a reconfigurable processor in which connections and settings of circuit cells within the LSI are reconfigurable.

Furthermore, if integrated circuit technology that replaces LSI appear thorough progress in semiconductor technology or other derived technology, that technology can naturally be used to carry out integration of the functional blocks. Biotechnology is anticipated to apply.

Alternatively, it is also good to configure a storage medium for storing data to be coded in a chip separately from a chip into which the other functional blocks are integrated.

As described above, for example, the vertical width of the first P-slice region (the NoMC-P-slice 42) may be equal to or greater than “a width obtained by subtracting a width of the I-slice from a width of a search range for motion estimation in the performing second inter coding”.

In this way, it is possible to exclude a wider portion in a reference range used for reference from the refreshed region, from an unrefreshed region of the reference picture (reference picture PR).

Furthermore, it is also good to select, as an I-slice insertion scheme, either a first insertion scheme (S2005A) of inserting an I-slice repeatedly, or a second insertion scheme (S2005C) of inserting I-slices only in a predetermined number of cycles, based on a bandwidth of a network for transmitting data of the coded pictures.

It is also good to configure a moving picture coding method including a selection process of selecting, as an I-slice insertion scheme, either a first insertion scheme of inserting I-slices repeatedly in cycles or a second insertion scheme of inserting I-slices only in a predetermined number of cycles, based on whether or not a receiver side that receives transmitted data notifies a coding apparatus that performs coding of occurrence of a decoding error at the receiver side (S2003).

In addition, it is also good to select, as an I-slice insertion scheme, either a first insertion scheme of inserting an I-slice repeatedly, or a second insertion scheme of inserting I-slices only in a predetermined number of cycles, based on a transmission scheme (S2001) for multicasting to other receivers.

In addition, the moving picture coding method may include deblocking filtering (filter unit 2010, Sa4), wherein a vertical width of the first region is greater than a maximum value for a distance (for example, 2-pixel distance) between two pixels one of which affects the other pixel in the deblocking filtering.

Alternatively, the motion vector may be estimated in a unit smaller than a pixel (motion compensation may be performed at a sub-pixel accuracy), and a vertical width of the first region is greater than a maximum value for a distance (for example, 3-pixel distance) between two pixels one of which affects the other pixel in motion compensation based on the motion vector. The height in the vertical direction may correspond to, for example, the size of larger than the minimum size for preventing reference from a refreshed region (refreshed region PS1) to a margin that ranges from an unrefreshed region (unrefreshed region PR3) to a position distant from the unrefreshed region by a total distance of the two maximum values in the filtering and the motion compensation with sub-pixel accuracy.

More specifically, for example, the width in the vertical direction may be a width obtained by adding a width considering the influence of a filtering process to a width considering influence other than the influence of the filtering process.

The vertical width of the first P-slice region may be greater than a search range for motion estimation in the second coding process.

The bottom end of the search range is above the top end of the I-slice of a current picture to be coded (a current picture PS). More specifically, in an exemplary case where the position of the top end of the I-slice of the current picture is co-located with the position of the bottom end of the I-slice of the reference picture (reference picture PR), the bottom end of the search range is above the bottom end of the I-slice of the reference picture. Thus, the bottom end of the search range is above the top end of the unrefreshed region of the reference picture. In this way, it is possible to prevent undesirable image quality degradation propagation more sufficiently.

The above-description refers to the width obtained by subtracting the width of the I-slice from the width of the search range for the motion estimation. On the other hand, the width of the NoMC-P-slice 42 in (n) in FIG. 2 may be the same as the width W of the search range shown in, for example, (m). In short, this width may be the same as W, equal to or greater than W, or smaller than W. In this way, it is also good to partly prevent propagation from an unrefreshed region PR3 to a refreshed region PS1 using a value smaller than W. In this way, such propagation is prevented. Meanwhile, the width of the NoMC-P-slice 42 is made comparatively smaller, resulting in a reduction in the data amount required to code the NoMC-P-slice 42. In this way, it is possible to achieve both prevention of such propagation and reduction in the amount of coded data.

The width of the search range may be, for example, the width (W) in the downward direction in FIG. 2, that is, in the forward direction for a current I-slice, and may be the maximum value for the distance within which forward-direction search is made.

In addition, the width of the first P-slice region may be, for example, equal to or greater than the search range (the maximum value for the distance used for search). In this way, it is possible to prevent undesirable image quality degradation propagation more sufficiently. Furthermore, the width of the first P-slice region may be, specifically, equal to or greater than a total of the maximum value for the distance used for search and the distance having the maximum value as the distance used for a deblocking filter. The width of the first P-slice region may be, specifically, equal to or greater than a total of the maximum value for the distance used for search and the distance having the maximum value as the distance used for motion compensation with sub-pixel accuracy. The width of the first P-slice region may be, specifically, equal to or greater than a total of these three lengths.

In this way, as shown in the letters of “starting point” and “ending point” in FIG. 3, a starting slice (and an ending slice) in a picture may be selected, for example, from among plural slices (slices to [6] in FIG. 3). In this way, the position of each slice (for example, the NoMC-P-slice [0]) may be specified in the picture. In this way, the slice (the NoMC-P-slice [0]) may be set at the specified position.

In this way, a current I-slice ([1]) may be set at the position at a time point (for example, a time point for (d)) which is next to the position at the immediately-preceding time point (the time point for c)).

Details described above are mere examples, and thus other embodiments are possible. Examples of such embodiments include an embodiment in which a publicly known technique is applied, and a modification obtained by further modifying the present invention.

Moving picture coding methods and moving picture coding apparatuses according to the present invention have been described above based on the above embodiments. However, the present invention is not limited to these embodiments. Those skilled in the art will readily appreciate that various kinds of modifications are possible in the exemplary embodiments and other embodiments obtained by arbitrarily combining the structural elements in the embodiments are also possible without materially departing from the novel teachings and advantages of the present invention. Accordingly, all such modifications are intended to be included within the scope of this invention.

### INDUSTRIAL APPLICABILITY

The present invention is applicable to moving picture coding apparatuses, and in particular to bi-directional communication or distribution of moving pictures using networks, and communication apparatuses or set apparatuses which code moving pictures such as monitoring cameras.

### REFERENCE SIGNS LIST

100 Number-of-pictures counting unit

102 Number-of-blocks counting unit

103 Slice type setting unit

104 Motion search determining unit

105 Number-of-cycles-of-slice-insertion setting unit

200 Coding unit

300 Packetizing unit

2001 Motion estimation unit

2002 Motion compensation unit

2003 Reference image copying unit

2004 Intra prediction unit

2005 Selector unit

2006 Subtractor

2007 DCT and Quantization unit

2008 Inverse quantization and inverse DCT unit

2009 Adder

2010 Filter unit

2011 Reference image storing unit

2012 Entropy coding unit

1. A moving picture coding method of coding pictures each including an I-slice and P-slices such that a position of a current I-slice that is set for a current picture to be coded among the pictures is shifted in a vertical direction of the current picture, said moving picture coding method comprising:
performing first inter coding, without using a motion vector, on one or more first P-slices in a first region in the current picture, the first region being adjacent to the current I-slice in a direction opposite to a forward direction for the shift in the vertical direction; and
performing second inter coding, using a motion vector, on a second P-slice in a second region that is other than the first region within the current picture.

2. The moving picture coding method according to claim 1,
wherein a vertical width of the first region is equal to or greater than a width obtained by subtracting a width of the I-slice from a width of a search range for motion estimation in said performing second inter coding.

3. The moving picture coding method according to claim 1, further comprising
performing third inter coding, using a motion vector, on another one of the first P-slices in the first region,
wherein, in said performing third inter coding, said third inter coding is performed, using the motion vector, on the other one of the first P-slices in the first region when an I-slice is inserted repeatedly, and
in said performing first inter coding, said first inter coding is performed, without using a motion vector, on the one or more first P-slices in the first region when I-slices are inserted only in a predetermined number of cycles.

4. The moving picture coding method according to claim 3, further comprising
selecting, as an I-slice insertion scheme, either a first insertion scheme of inserting an I-slice repeatedly, or a second insertion scheme of inserting I-slices only in a predetermined number of cycles, based on a bandwidth of a network for transmitting data of the coded pictures.

5. The moving picture coding method according to claim 3, further comprising
selecting, as an I-slice insertion scheme, either a first insertion scheme of inserting an I-slice repeatedly, or a second insertion scheme of inserting I-slices only in a predetermined number of cycles, based on whether or not a receiver side which receives data transmitted notifies a coding apparatus which performs coding of an occurrence of a decoding error at the receiver side.

6. The moving picture coding method according to claim 3, further comprising
selecting, as an I-slice insertion scheme, either a first insertion scheme of inserting an I-slice repeatedly, or a second insertion scheme of inserting I-slices only in a predetermined number of cycles, based on a transmission scheme for multicasting to other receivers.

7. The moving picture coding method according to claim 1, further comprising
deblocking filtering,
wherein a vertical width of the first region is greater than a maximum value for a distance between two pixels one of which affects the other pixel in said deblocking filtering.

8. The moving picture coding method according to claim 1,
wherein the motion vector is estimated in a unit smaller than a pixel, and
a vertical width of the first region is greater than a maximum value for a distance between two pixels one of which affects the other pixel in motion compensation based on the motion vector.

9. The moving picture coding method according to claim 1,
wherein, in said performing first inter coding, said first inter coding is performed, without using a motion vector, on each of the first P-slices in the first region, and
a maximum value for a size of each of the first P-slices is smaller than a maximum value for a size of the second P-slice.

10. The moving picture coding method according to claim 9,
wherein the maximum value for the size of the first P-slice is equal to or larger than the size of the I-slice in the picture including the first P-slices each having a size of the maximum value.

11. The moving picture coding method according to claim 1,
wherein a first picture and a second picture among the pictures each including an I-slice and P-slices are coded, the first picture being at a first time point, and the second picture being at a second time point later than the first time point, and
a third picture is coded, the third picture not including any I-slice, and being at an intermediate time point between the first time point and the second time point.

12. The moving picture coding method according to claim 11,
wherein the third picture includes a region corresponding to a region including the first region and the I-slice region in the first picture,
in said performing first inter coding, said first inter coding is performed, without using a motion vector, on the first P-slice in the region in the third picture, and
in said performing second inter coding, said second inter coding is performed, using the motion vector, on the second P-slices in regions that are other than the region within the third picture.

13. The moving picture coding method according to claim 11,
wherein the third picture includes a co-located region co-located with the first region in the second picture,
in said performing first inter coding, said first inter coding is performed, without using a motion vector, on first P-slices in the co-located region in the third picture, and
in said performing second inter coding, said second inter coding is performed, using the motion vector, on second P-slices in the regions that are other than the co-located region within the third picture.

14. The moving picture coding method according to claim 12,
wherein, in said performing first inter coding, said first inter coding is performed, without using a motion vector, on each of the first P-slices in the regions in the third picture, and
a maximum value for a size of each of the first P-slices in the third picture is smaller than a maximum value for a size of the second P-slice in the third picture.

15. The moving picture coding method according to claim 13,
wherein, in said performing first inter coding, said first inter coding is performed, without using a motion vector, on each of the first P-slices in the regions in the third picture, and
a maximum value for a size of each of the first P-slices in the third picture is smaller than a maximum value for a size of the second P-slice in the third picture.

16. A moving picture coding apparatus which codes pictures each including an I-slice and P-slices such that a position of a current I-slice that is set for a current picture to be coded among the pictures is shifted in a vertical direction of the current picture, said moving picture coding apparatus comprising:
a slice type determining unit configured to determine slice types of the P-slices, so that first inter coding is performed, without using a motion vector, on one or more first P-slices in a first region in the current picture, the first region being adjacent to the current I-slice in a direction opposite to a forward direction for the shift in the vertical direction, and second inter coding is performed, using a motion vector, on a second P-slice in a second region that is other than the first region within the current picture;
a first inter coding unit configured to perform the first inter coding, without using a motion vector, on the one or more first P-slices in the first region; and
a second inter coding unit configured to perform the second inter coding, using a motion vector, on the second P-slice in the second region.

17. The moving picture coding apparatus according to claim 16, comprising
a number-of-cycles-of-slice-insertion setting unit configured to determine whether or not the number of cycles of insertion of I-slices is equal to or larger than a predetermined value,
wherein said slice type determining unit is configured to determine that the slice types of the P-slices indicate the one or more first P-slices included in the first region and the second slice included in the second region when said number-of-cycles-of-slice-insertion setting unit determines that the number of cycles of insertion is not larger than the predetermined value, and determine that the slice types of the P-slices indicate second P-slices included in the second region when said number-of-cycles-of-slice-insertion setting unit determines that the number of cycles of insertion is equal to or larger than the predetermined value.

18. A computer program for causing a computer to code pictures each including an I-slice and P-slices such that a position of a current I-slice that is set for a current picture to be coded is shifted in a vertical direction of the current picture, said computer program causing the computer to execute:
performing first inter coding, without using a motion vector, on one or more first P-slices in a first region in the current picture, the first region being adjacent to the current I-slice in a direction opposite to a forward direction for the shift in the vertical direction; and
performing second inter coding, using a motion vector, on a second P-slice in a second region that is other than the first region within the current picture.

19. An integrated circuit which codes pictures each including an I-slice and P-slices such that a position of a current I-slice that is set for a current picture to be coded among the pictures is shifted in a vertical direction of the current picture, said integrated circuit comprising:
a first inter coding unit configured to perform first inter coding, without using a motion vector, on one or more first P-slices in a first region in the current picture, the first region being adjacent to the current I-slice in a direction opposite to a forward direction for the shift in the vertical direction; and
a second inter coding unit configured to perform second inter coding; using a motion vector, on a second P-slice in a second region that is other than the first region within the current picture.
